(19) United States
(12) Patent Application Publication
(10) Pub. No.: US 2026/0209499 A1
(43) Pub. Date: Jul. 23, 2026

(54) Elastomer Blends Comprising Brominated Isobutylene-P-Methylstyrene Copolymers and Tires or Tire Components Containing Same

(71) Applicant: ExxonMOBILE Chemical Patents Inc,, Spring, TX (US)

(72) Inventors: Babu SHANMUGASUNDARUM, Bangalore, Whitefield (IN); Appues P., Chennai, Taminadu (IN); Shanawas CK, Bangalore, Karnataka (IN); Sunny JACOB, Seabrook, TX (US); Eric J. WAMSLEY, Baytown, TX (US)

(21) Appl. No.: 19/137,935

(22) PCT Filed: Dec. 7, 2023
(86) PCT No.: PCT/US2023/082913

§ 371 Date: Jun. 11, 2025

Related U.S. Application Data
(60) Provisional application No. 63/432,751, filed on Dec. 15, 2022.

(51) Int. Cl. C08L 23/283; B60C 1/00; C08L 7/00; C08L 23/22

(52) U.S. Cl. CPC C08L 23/283; C08L 7/00; C08L 23/22; B60C 1/0008; C08L 2312/02

(57) ABSTRACT

Elastomer blends may comprise about 25 wt % or above of a brominated isobutylene-p-methylstyrene copolymer, based on total polymer mass and a non-zero amount of a companion elastomer. The companion elastomer is not a bromobutyl rubber, and the brominated isobutylene-p-methylstyrene copolymer is free of a diene comonomer. Suitable companion elastomers may include, but are not limited to, bromobutyl rubber and natural or synthetic polyisoprene. Advantaged properties may be realized with specified amounts of each companion elastomer. The elastomer blends may be utilized in various locations within tires or components used for making tires.

### CROSS-REFERENCE TO RELATED APPLICATION

This application claims priority to and the benefit of U.S. Provisional Patent Application 63/432,751, filed 15 Dec. 2022, entitled Elastomer Blends Comprising Brominated Isobutylene-P-Methylstyrene Copolymers and Tires or Tire Components Containing Same, the disclosure of which is incorporated herein by reference in its entirety.

### FIELD

The present disclosure relates to elastomer blends that include brominated isobutylene-p-methylstyrene copolymers. Such elastomer blends may be useful for producing a variety of tire components or components used in conjunction with tire manufacturing.

### BACKGROUND

Tires are strong, flexible rubber casings attached to the rim of a wheel on a vehicle (e.g., a car, bicycle, truck, bus, airplane, or the like). Depending on the target vehicle type, types may feature different types of engineering and internal components that provide a high degree of comfort, performance, efficiency, reliability and safety. In addition, tires may utilize a range of different types of rubber components (elastomers) in various locations to provide durability and chemical resistance for a range of potential operating environments. In addition to the rubber components, other additives such as carbon black and silica may be present to provide reinforcement for improving properties such as tear strength, tensile strength, and abrasion resistance within elastomer blends (rubber blends). Antioxidants, antiozonants, and curing agents (curatives) may also be present in elastomer blends used for producing various components within a tire.

FIG. 1 is a diagram of a portion of an illustrative tire. As shown, tire 100 includes tire sidewall 102, first belt 104, second belt 106, tread 108, bead 110, inner liner 112, first body ply 114, and second body ply 116. Elastomer blends of various types may be used in these various tire components. An inner tube (not illustrated) is an inflatable tube containing air that is placed in between a metal rim of a wheel and inner liner 112 for tube-type tires. Plies 114 and 116 convey structure to tire 100 and provide strength to contain inflation pressure in the inner tube. Plies 114 and 116 also give the tire strength and flexibility, as well as maintain the shape of tire 100 under various road conditions. Bead 110 assures an air-tight fit to the wheel. First and second belts 104 and 106 provide stability and strength to tread 108 of tire 100. Inner liner 112 comprises an elastomer blend having a low gas permeability to promote further retention of the inflation pressure provided by the inner tube. Sidewall 102 covers plies 114 and 116 on the sides of tire 100 and provides protection from road and curb damage. An elastomer blend within sidewall 102 may be formulated for toughness and resistance to degradation by ozone. Tread 108 utilizes a tread pattern and elastomer blend suitable to provide grip and traction. Elastomer blends may also be present in components used for constructing tires, such as inflation bladders, for example.

Both natural and synthetic rubber compounds may be present in elastomer blends utilized at various locations within tires or components used for forming tires. Natural rubber may provide tear and fatigue crack resistance in tire components requiring these properties. Common synthetic rubber compounds utilized in tires include butadiene rubber, styrene-butadiene rubber, and butyl rubber (polyisobutylene). Other commonly used synthetic rubber compounds include halogenated polyisobutylene rubbers, commonly known as halobutyl rubbers, which include chlorobutyl rubber and bromobutyl rubber. Halobutyl rubbers may be used, for example, to make the inner liner of a tire relatively impermeable and help maintain inflation pressure. In addition, halobutyl rubbers may undergo more rapid curing (crosslinking/vulcanization) than does butyl rubber itself. Brominated isobutylene-p-methylstyrene copolymers may also be present in tire components in some cases. The saturated polymer backbone and bulky phenyl group of such copolymers may afford improved heat resistance and decreased gas permeability compared to other types of synthetic rubber. Several grades of brominated isobutylene-p-methylstyrene copolymers are available from ExxonMobil Product Solutions under the trade name EXXPRO.

### SUMMARY

In some aspects, the present disclosure describes elastomer blends comprising: about 25 wt % or above of a brominated isobutylene-p-methylstyrene copolymer, based on total polymer mass; and a non-zero amount of a companion elastomer; wherein the companion elastomer is not a bromobutyl rubber; and wherein the brominated isobutylene-p-methylstyrene copolymer is free of a diene comonomer.

In some or other aspects, the present disclosure describes tires, components used for forming tires, or bushings comprising the foregoing elastomer blends in vulcanized form.

These and other features and attributes of the disclosed compositions and methods of the present disclosure and their advantageous applications and/or uses will be apparent from the detailed description which follows.

### BRIEF DESCRIPTION OF THE DRAWINGS

To assist one of ordinary skill in the relevant art in making and using the subject matter hereof, reference is made to the appended drawings. The following figures are included to illustrate certain aspects of the disclosure, and should not be viewed as exclusive configurations. The subject matter disclosed is capable of considerable modifications, alterations, combinations, and equivalents in form and function, as will occur to those skilled in the art and having the benefit of this disclosure.

FIG. 1 is a diagram of a portion of an illustrative tire.

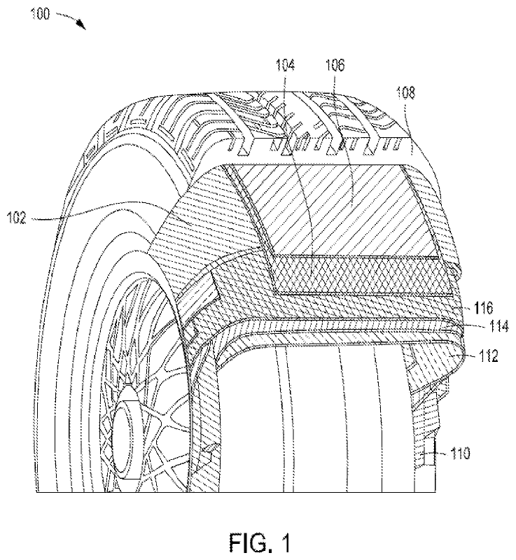

FIGS. 2 and 3 are plots of tensile strength retention and tear strength retention, respectively, after aging the samples of Example 1 under hot air aging at 125° C. for 3 days or 7 days.

FIG. 4 is a plot of cure rate index (CRI) for the elastomer blends of Example 1.

### DETAILED DESCRIPTION

The present disclosure relates to elastomer blends that include brominated isobutylene-p-methylstyrene copolymers. Such elastomer blends may be useful for producing a variety of tire components or components used in conjunction with tire manufacturing.

Elastomer blends containing various rubber compounds may be utilized in one or more components of a tire. Depending on location within the tire, a given rubber compound may be chosen to impart one or more desired qualities to the tire. Among the polymers that may be incorporated in various components of tires include brominated isobutylene-p-methylstyrene copolymers.

As described herein, elastomer blends containing a brominated isobutylene-p-methylstyrene copolymer in combination with suitable amounts of specified companion elastomers may afford a surprising enhancement in one or more properties of the brominated isobutylene-p-methylstyrene copolymer and/or the companion elastomer alone. In addition, the elastomer blends disclosed herein may afford improved performance in some cases over comparative elastomer blends conventionally used in various tire components, thereby facilitating fabrication of tires that are advantaged in one or more aspects. Such comparative elastomer blends may or may not include the brominated isobutylene-p-methylstyrene copolymer and/or the companion elastomer. Advantageously, depending on the chosen companion elastomer and an amount thereof used in combination with the brominated isobutylene-p-methylstyrene copolymer, the properties of the elastomer blends disclosed herein may be tailored for incorporation at a specified location within a tire or a tire manufacturing process to afford a beneficial enhancement thereof. Thus, the present disclosure provides brominated isobutylene-p-methylstyrene copolymers as an in-common elastomeric source material that may be formulated in various ways through blending with a given companion elastomer to facilitate fabrication of tire components of particular types and having a range of desired properties.

All numerical values within the detailed description and the claims herein are modified by “about” or “approximately” with respect to the indicated value, and take into account experimental error and variations that would be expected by a person having ordinary skill in the art.

As used in the present disclosure and claims, the singular article forms “a,” “an,” and “the” include plural forms unless the context clearly dictates otherwise.

The term “and/or” as used in a phrase such as “A and/or B” herein is intended to include “A and B,” “A or B,” “A,” and “B.”

For the purposes of the present disclosure, the new numbering scheme for groups of the Periodic Table is used. In said numbering scheme, the groups (columns) are numbered sequentially from left to right from 1 through 18.

Unless otherwise indicated, room temperature (RT) is about 23° C.

The term “phr” means parts per hundred parts of rubber, and is a measure common in the art wherein components of an elastomer blend are measured relative to the total mass of all of the elastomer (rubber) components present therein. The total phr or parts for all rubber components, whether one, two, three, or more different rubber components present in a given elastomer blend, is always defined as 100 phr. All other non-rubber components of the elastomer blend are specified as a ratio against the 100 parts of rubber and are expressed in phr.

The term “elastomer,” as used herein, refers to any polymer or combination of polymers consistent with the ASTM D1566 definition, incorporated herein by reference. As used herein, the term “elastomer” may be used interchangeably with the term “rubber.”

The terms “vulcanization,” “vulcanized,” and other grammatical forms thereof refer to crosslinking of one or more elastomers within an elastomer blend.

The elastomer blends of the present disclosure may comprise about 10 wt % or above, or about 20 wt % or above, or about 25 wt % or above of a brominated isobutylene-p-methylstyrene copolymer, based on total polymer mass; and a non-zero amount of a companion elastomer. Preferably, the companion polymer is not a bromobutyl rubber and/or the brominated isobutylene-p-methylstyrene copolymer is free of a diene comonomer. Depending on the companion elastomer and the amount thereof, advantaged properties may be realized such as, for example, improved impermeability, flex fatigue, thermal and oxidative stability, steam aging performance, and the like. In more specific examples, the brominated isobutylene-p-methylstyrene copolymer may be present in the elastomer blends in an amount of about 10 wt % to 95 wt %, or about 20 wt % to 75 wt %, or about 25 wt % to 90 wt %, or about 50 wt % to 90 wt %, or about 30 wt % to 70 wt %, or about 50 wt % to 70 wt %, or about 25 wt % to about 80 wt %, or about 25 wt % to about 50 wt %, or about 10 wt % to about 50 wt %, or about 10 wt % to about 30 wt %, each based on total polymer mass within the elastomer blend. The amount of brominated isobutylene-p-methylstyrene copolymer present in the elastomer blends may differ based on a desired application or component to be produced, such as a given component of a tire or component used in making a tire. For example, for a tire inner tube, the brominated isobutylene-p-methylstyrene copolymer may, more preferably, be present in the elastomer blend in an amount of about 25 wt % to 95 wt %, or about 25 wt % to 90 wt %, or about 50 wt % to 90 wt %, or about 30 wt % to 70 wt %, or about 50 wt % to 70 wt %), based on total polymer mass within the elastomer blend. In another example, for inner liners where improved adhesion is desired, the brominated isobutylene-p-methylstyrene copolymer may, more preferably, be present in the elastomer blend in an amount of about 50 wt % to 90 wt %, or about 50 wt % to 80 wt %, or about 60 wt % to 90 wt %, or about 70 wt % to 90 wt %, based on total polymer mass within the elastomer blends. In still another example, for tire bladders used for making a tire, the brominated isobutylene-p-methylstyrene copolymer may, more preferably, be present in the elastomer blend in an amount of about 10 wt % to 95 wt %, or about 20 wt % to 75 wt %, or about 25 wt % to 70 wt %, or about 20 wt % to 50 wt %, or about 10 wt % to about 30 wt %, or about 10 wt % to about 20 wt %, or about 20 wt % to about 30 wt %, based on total polymer mass within the elastomer blends. In yet another example, for a bushing (e.g., a silent block rubber bushing), the brominated isobutylene-p-methylstyrene copolymer may, more preferably, be present in the elastomer blend in an amount of about 30 wt % to 50 wt %, or about 30 wt % to 45 wt %, or about 35 wt % to 50 wt %, or about 35 wt % to about 45 wt %, based on total polymer mass within the elastomer blend.

Examples of suitable companion elastomers may include, but are not limited to, a butyl rubber, a polyisoprene (natural rubber and/or synthetic rubber), the like, and any combination thereof. In non-limiting examples, the brominated isobutylene-p-methylstyrene copolymer and the companion elastomer may comprise the entirety of the polymers in the elastomer blends described herein. Thus, the brominated isobutylene-p-methylstyrene copolymer and the companion elastomer may sum to 100 parts rubber in the elastomer blends described herein. Stated alternately, if the brominated isobutylene-p-methylstyrene copolymer is present at a weight percent ranging from A to B, the companion elastomer may be present at a weight percentage ranging from 100−B to 100−A. Further alternately, total rubber in the elastomer blends disclosed herein may consist of the brominated isobutylene-p-methylstyrene copolymer and the companion elastomer.

In non-limiting examples, the butyl rubber may comprise an isobutylene-isoprene copolymer. Preferably, the isobutylene-isoprene copolymer may contain 0.5 mol % to 3 mol % isoprene with the balance being isobutylene. Examples of commercially available butyl rubbers may include, but are not limited to, EXXON™ BUTYL 365, EXXON™ BUTYL 065, EXXON™ BUTYL 065S, EXXON™ BUTYL 068, EXXON™ BUTYL 068S, EXXON™ BUTYL 268, EXXON™ BUTYL 268S (each being a butyl rubber that is a copolymer of isobutylene and isoprene, available from ExxonMobil Product Solutions), and any combination thereof. In any embodiment herein, suitable butyl rubbers may be a non-halogenated butyl rubber. Hence, butyl rubbers suitable for use as companion polymers in the disclosure herein exclude chlorobutyl rubber, bromobutyl rubber, or any combination thereof. The elastomer blends may thus comprise no to essentially no (less than about 1 wt %, based on total mass of the elastomer blend) bromobutyl rubber and/or chlorobutyl rubber.

Butyl rubbers suitable for use as the companion elastomer may have a Mooney viscosity (ML 1+8, 125° C., ASTM D1646-19a) ranging from about 30 Mooney units (MU) to about 60 MU, or about 30 MU to about 45 MU, or about 40 MU to about 60 MU.

Herein, the term “polyisoprene” refers to either natural rubber or synthetic polyisoprene unless specified otherwise, either of which may be suitable for use as a companion elastomer herein. Preferably, natural rubber is used when polyisoprene is selected as the companion elastomer. Natural rubber may be obtained from any suitable source. Examples of natural rubbers that may be suitable may include, but are not limited to, natural rubber technically specified rubber (TSR) grade 20 or ribbed smoke sheet (RSS) grade 2 or grade 3 or grade 4, the like, and any combination thereof.

The Mooney viscosity (ML 1+4, 100° C., ASTM D1646-19a) of suitable polyisoprene rubbers may range from about 35 MU to about 70 MU, or about 40 MU to about 65 MU, or about 45 MU to about 60 MU.

Examples of commercially available brominated isobutylene-p-methylstyrene copolymers may include, but are not limited to, EXXPRO™ 3433, EXXPRO™ 3035, and EXXPRO™ 3563, all available from ExxonMobil Product Solutions.

In non-limiting examples, the brominated isobutylene-p-methylstyrene copolymer may comprise (i) about 3 wt % to about 12 wt %, or about 4 wt % to about 11 wt %, or about 5 wt % to about 10 wt % p-methylstyrene or brominated p-methylstyrene monomer units and (ii) about 0.3 mol % to about 1.0 mol %, or about 0.4 mol % to about 0.9 mol %, or about 0.5 mol % to about 0.8 mol % bromine, each based on total mass of the brominated isobutylene-p-methylstyrene copolymer.

In non-limiting examples, the brominated isobutylene-p-methylstyrene copolymer may have a Mooney viscosity (ML 1+8, 125° C., ASTM D1646-19a) ranging from about 30 Mooney units (MU) to about 50 MU, or about 30 MU to about 45 MU, or about 35 MU to about 50 MU.

In some examples, the elastomer blends disclosed herein may comprise about 25 wt % to about 90 wt % brominated isobutylene-p-methylstyrene copolymer, based on total polymer mass, wherein the brominated isobutylene-p-methylstyrene copolymer has a Mooney viscosity (ML 1+8, 125° C., ASTM D1646-19a) ranging from about 30 MU to about 50 MU and/or the brominated isobutylene-p-methylstyrene copolymer comprises about 5 wt % to about 10 wt % p-methylstyrene or brominated p-methylstyrene monomer units and about 0.5 mol % to about 0.8 mol % bromine, each based on total mass of the brominated isobutylene-p-methylstyrene copolymer. In more specific examples, the elastomer blends disclosed herein may comprise about 30 wt % to about 50 wt % brominated isobutylene-p-methylstyrene copolymer, based on total polymer mass, wherein the brominated isobutylene-p-methylstyrene copolymer has a Mooney viscosity (ML 1+8, 125° C., ASTM D1646-19a) of about 35 MU and/or the brominated isobutylene-p-methylstyrene copolymer comprises about 5 wt % p-methylstyrene or brominated p-methylstyrene monomer units and about 0.7 mol % bromine, each based on total mass of the brominated isobutylene-p-methylstyrene copolymer. The companion elastomer may comprise polyisoprene, preferably natural rubber in any of the foregoing.

In some or other non-limiting examples, the elastomer blends disclosed herein may comprise about 25 wt % to about 90 wt % brominated isobutylene-p-methylstyrene copolymer, preferably about 30 wt % to about 70 wt %, based on total polymer mass, wherein the brominated isobutylene-p-methylstyrene copolymer has a Mooney viscosity (ML 1+8, 125° C., ASTM D1646-19a) ranging from about 30 MU to about 50 MU and/or the brominated isobutylene-p-methylstyrene copolymer comprises about 5 wt % to about 10 wt % p-methylstyrene or brominated p-methylstyrene monomer units and about 0.5 mol % to about 0.8 mol % bromine, each based on total mass of the brominated isobutylene-p-methylstyrene copolymer. In more specific examples, the elastomer blends disclosed herein may comprise about 30 wt % to about 50 wt % brominated isobutylene-p-methylstyrene copolymer, based on total polymer mass, wherein the brominated isobutylene-p-methylstyrene copolymer has a Mooney viscosity (ML 1+8, 125° C., ASTM D1646-19a) of about 35 MU and/or the brominated isobutylene-p-methylstyrene copolymer comprises about 5 wt % p-methylstyrene or brominated p-methylstyrene monomer units and about 0.7 mol % bromine, each based on total mass of the brominated isobutylene-p-methylstyrene copolymer. In other more specific examples, the brominated isobutylene-p-methylstyrene copolymer may have a Mooney viscosity (ML 1+8, 125° C., ASTM D1646-19a) of about 45 MU and/or the brominated isobutylene-p-methylstyrene copolymer comprises about 5 wt % p-methylstyrene or brominated p-methylstyrene monomer units and about 0.5 mol % bromine, each based on total mass of the brominated isobutylene-p-methylstyrene copolymer. The companion elastomer may comprise butyl rubber in any of the foregoing.

In some or other examples, the elastomer blends disclosed herein may comprise about 50 wt % to about 90 wt % brominated isobutylene-p-methylstyrene copolymer, based on total polymer mass, wherein the brominated isobutylene-p-methylstyrene copolymer has a Mooney viscosity (ML 1+8, 125° C., ASTM D1646-19a) of about 35 MU and/or the brominated isobutylene-p-methylstyrene copolymer comprises about 10 wt % p-methylstyrene or brominated p-methylstyrene monomer units and about 0.8 mol % bromine, each based on total mass of the brominated isobutylene-p-methylstyrene copolymer. The companion elastomer may comprise butyl rubber in any of the foregoing.

The elastomer blends of the present disclosure may optionally include one or more additives customarily used in elastomer blends, such as crosslinking and curing materials, accelerators, processing aids, antioxidants, antiozonants, pigments, plasticizers, tackifiers, extenders, chemical conditioners, homogenizing agents, processing oils, waxes, hydrocarbon resins, rosins, the like, and any combination thereof. Individual additives may be present in the elastomer blends disclosed herein in an amount from about 1 phr to about 50 phr, or about 1 phr to about 30 phr, or about 5 phr to about 25 phr, or about 15 phr to about 40 phr, or about 30 phr to about 50 phr.

Suitable crosslinking and curing agents may include, but are not limited to, sulfur, zinc oxide, and fatty acids. Generally, elastomers can be crosslinked by adding active molecules, for example sulfur, metal oxides (e.g., zinc oxide), organometallic compounds, and/or radical initiators, followed by heating. For example, the following metal oxides are common curatives that may be suitable additives in the present disclosure: ZnO, CaO, MgO, Al₂O₃, CrO₃, FeO, Fe₂O₃, and NiO. These metal oxides may be used when present as the cation in a corresponding metal stearate complex (e.g., Zn(stearate)₂, Ca(stearate)₂, Mg(stearate)₂, and Al(stearate)₃), or with stearic acid, and a sulfur compound. Conventional vulcanization techniques for natural rubber blends may also be applied to the elastomer blends of the present disclosure. Thus, in any embodiment herein, the elastomer blend disclosed herein may be vulcanized.

Accelerators may include, but are not limited to, amines, guanidines, thioureas, thiazoles, thiurams, sulfenamides, sulfenimides, thiocarbamates, xanthates, the like, and any combination thereof. Acceleration of a curing process may be accomplished by adding an amount of the accelerator to the elastomer blend and performing curing as described herein. The mechanism for accelerated vulcanization may involve complex interactions between the curative, accelerator, activators, and polymers. Preferably, the entire available curative is consumed during the formation of effective crosslinks joining two polymer chains together to enhance the overall strength of the polymer matrix. Examples of specific accelerators may include, but are not limited to, stearic acid, N-cyclohexyl-2-benzothiazole sulfenamide (CBS), diphenyl guanidine (DPG), tetramethylthiuram disulfide (TMTD), dipentamethylenethiuram tetrasulfide (DPTT), 4,4′-dithiodimorpholine (DTDM), tetrabutylthiuram disulfide (TBTD), 2,2′-benzothiazyl disulfide (MBTS), hexamethylene-1,6-bisthiosulfate disodium salt dihydrate, 2-(morpholinothio) benzothiazole (MBS or MOR), compositions of 90% MOR and 10% MBTS (MOR 90), N-tertiarybutyl-2-benzothiazole sulfenamide (TBBS), and N-oxydiethylene thiocarbamyl-N-oxydiethylene sulfonamide (OTOS), zinc 2-ethyl hexanoate (ZEH), N,N′-diethyl thiourea.

A cure system (cure package) may include one or more components described above that facilitate or influence the cure of elastomers, such as metals, accelerators, sulfur, and other agents. For example, a sulfur cure system comprising sulfur and a sulfur donor may be used to promote curing of the elastomer blends of the present disclosure, in which sulfur is present in an amount less than 5 phr and at least one sulfur donor is present in an amount less than 5 phr. Preferably, the sulfur donor may comprise at least one of TMTD and DPTT.

Suitable processing aids may include, but are not limited to, SUNDEX™ (available from Sun Chemicals) and FLEXON™ (available from ExxonMobil Product Solutions).

Suitable plasticizers may include, but are not limited to, polyalphaolefins (PAOs), high purity hydrocarbon fluid compositions (HPFCs) and Group III basestocks such as those described in WO 2004/014998. Preferred PAOs may include oligomers of decene and co-oligomers of decene and dodecene. Preferred PAOs are available under the trade name SUPERSYN™, SPECTRASYN™ PAO, and ELEVAST™, each available from ExxonMobil Product Solutions.

Suitable hydrocarbon resins may include, but are not limited to, ESCOREZ™ 1102, ESCOREZ™ 2520, ESCOREZ™ E5000, each being an aliphatic hydrocarbon resin, available from ExxonMobil Product Solutions), the like, and any combination thereof. Such hydrocarbon resins may act as tackifiers.

Suitable antioxidants may include, for example, 2,2,4-trimethyl-1,2-dihydroquinoline polymer (TMQ).

Suitable antiozonants may include, for example, N,N′-disubstituted-para-phenylenediamines, particularly the alkyl-, aryl-substituted versions such as N-1,3-dimethylbutyl-N-phenyl-para-phenylene diamine (“6PPD”), for example.

Suitable homogenizing agents may include, for example, STRUKTOL™ 40 MS (a mixture of aromatic and aliphatic hydrocarbon resins, available from Struktol Company of America), PROMIX™ 400 (a mixture of aliphatic, naphthenic, and aromatic hydrocarbon resins; an EVA copolymer; silicon dioxide; and magnesium silicate, available from HB Chemical), the like, and any combination thereof.

Suitable process oils may include, but are not limited to, naphthenic oils, paraffinic oils, aromatic oils, the like, and any combination thereof. Examples of suitable process oils may include IPOL 501 and IPOL 2300 (a paraffinic-type process oil with a high viscosity and flash point, available from GP Petroleums) and CALSOL-810 (naphthenic oil, Calumet Specialty Products).

The elastomer blends of the present disclosure may be characterized by one or more of the properties specified further below.

Mooney viscosity and Mooney scorch are determined herein according to ASTM D1646-19a. If measurement and test conditions are not specified, said conditions for Mooney viscosity are ML(1+4) and 125° C. and for Mooney scorch are T5 at 125° C.

The elastomer blends of the present disclosure may have a Mooney viscosity (ML(1+4) at 100° C.) of about 53.0 MU to about 73.0 MU.

The elastomer blends of the present disclosure may have a Mooney scorch (T5, 125° C.) of about 29.0 min or less, or about 6.5 min to about 10.0 min, or about 7.5 min to about 8.0 min, or about 8.0 min to about 11.0 min, or about 10.0 min to about 29.0 min, or about 10.0 min to about 20.0 min, or about 15.0 min to about 29.0 min.

The cure kinetics of elastomer blends of the present disclosure are measured using a MDR (moving die rheometer) as described in ASTM D5289-19a. If conditions are not specified, the conditions include a temperature of 180° C., a test time of 30 min, and a test angle of 0.5°.

The elastomer blends of the present disclosure may have a MH-ML (MDR, 180° C., 30 min, 0.5° test angle) of about 6.0 dNm or less, or about 3.0 dNm to about 6.0 dNm, or about 3.0 dNm to about 5.0 dNm, or about 3.0 dNm to about 4.4 dNm. ML is the minimum torque measured by the MDR (representing the unvulcanized elastomer blend) and MH is the maximum torque measured by the MDR.

Cure rate index is determined according to the method and equations described in US Pat. App. Pub. No. 2008/028762, incorporated herein by reference. The elastomer blends of the present disclosure may have a cure rate index of about 25 or greater, such as about 25 to about 60.

Hardness values of the elastomer blends are determined by ASTM D2240-15 (2021). Unless otherwise specified, the sample curing conditions are 160° C. and TC 90+2 MDR.

The elastomer blends of the present disclosure may have a hardness (original) of about 40 Shore A to about 55 Shore A, or about 40 Shore A to about 45 Shore A, or about 45 Shore A to about 55 Shore A.

The elastomer blends of the present disclosure may have a hardness (hot air aged 3 days at 125° C.) of about 40 Shore A to about 57 Shore A, or about 40 Shore A to about 46 Shore A, or about 40 Shore A to about 45 Shore A, or about 45 Shore A to about 57 Shore A, or about 54 Shore A to about 57 Shore A.

The elastomer blends of the present disclosure may have a hardness (hot air aged 7 days at 125° C.) of about 40 Shore A to about 44 Shore A.

The elastomer blends of the present disclosure may have a hardness retention (change in hardness) from original to aged (hot air aged 3 days at 125° C.) of about −5 Shore A to about 5 Shore A.

The elastomer blends of the present disclosure may have a hardness retention (change in hardness) from original to aged (hot air aged 7 days at 125° C.) of about −5 Shore A to about 5 Shore A.

Tensile properties (e.g., tensile strength, elongation at break, and modulus) are determined according to ASTM D412-16. Unless otherwise specified, the sample curing conditions are 160° C. and TC 90+2 MDR.

The elastomer blends of the present disclosure may have a tensile strength at break (original) of about 10.0 MPa to about 23.0 MPa, or about 10.0 MPa to about 12.0 MPa, or about 12.0 MPa to about 20.0 MPa, or about 18.0 MPa to about 23.0 MPa.

The elastomer blends of the present disclosure may have a tensile strength at break (hot air aged 3 days at 125° C.) of about 8.0 MPa to about 20.0 MPa, or about 8.0 MPa to about 9.0 MPa, or about 8.0 MPa to about 18.0 MPa, or about 15.0 MPa to about 9.0 MPa.

The elastomer blends of the present disclosure may have a tensile strength at break (hot air aged 7 days at 125° C.) of about 6.5 MPa to about 8.5 MPa.

The elastomer blends of the present disclosure may have a tensile strength at break retention (change in tensile strength) from original to aged (hot air aged 3 days at 125° C.) of about 13% to about 30%.

The elastomer blends of the present disclosure may have a tensile strength at break retention (change in tensile strength) from original to aged (hot air aged 7 days at 125° C.) of about 15% to about 45%.

The elastomer blends of the present disclosure may have an energy at break (original) of about 11.5 J to about 23.0 J, about 11.5 J to about 12.5 J, about 12.0 J to about 20.0 J, or about 17.0 J to about 23.0 J, or about 20.0 J to about 22.0 J.

The elastomer blends of the present disclosure may have an energy at break (hot air aged 3 days at 125° C.) of about 8.0 J to about 9.0 J.

The elastomer blends of the present disclosure may have an energy at break (hot air aged 7 days at 125° C.) of about 7.0 J to about 21.0 J, or about 7.0 J to about 8.5 J, or about 8.0 J to about 17.0 J, or about 16.0 J to about 21.0 J, or about 17.0 J to about 20.0 J.

Tear strength and tear resistance are determined according to ASTM D624-00.

The elastomer blends of the present disclosure may have a tear resistance (original) of about 34 N/mm to about 70 N/mm, or about 34 N/mm to about 38 N/mm, or about 37 N/mm to about 42 N/mm, or about 40 N/mm to about 60 N/mm, or about 55 N/mm to about 70 N/mm, or about 60 N/mm to about 70 N/mm.

The elastomer blends of the present disclosure may have a tear resistance (hot air aged 3 days at 125° C.) of about 28 N/mm to about 65 N/mm, or about 28 N/mm to about 34 N/mm, or about 32 N/mm to about 46 N/mm, or about 45 N/mm to about 65 N/mm, or about 50 N/mm to about 60 N/mm.

The elastomer blends of the present disclosure may have a tear resistance (hot air aged 7 days at 125° C.) of about 23 N/mm to about 30 N/mm.

The elastomer blends of the present disclosure may have a tear resistance retention (change in tear resistance) from original to aged (hot air aged 3 days at 125° C.) of about 12% to about 22%.

The elastomer blends of the present disclosure may have a tear resistance retention (change in tear resistance) from original to aged (hot air aged 7 days at 125° C.) of about 22% to about 30%.

Fatigue to Failure Lifetime Test (FTFT) is determined according to ASTM 4482-11.

The elastomer blends of the present disclosure may have a Fatigue to Failure Lifetime Test (FTFT) of about 35 kilocycles (KC) to about 120 KC, or about 35 KC to about 45 KC, or about 35 KC to about 55 KC, or about 50 KC to about 120 KC, or about 50 KC to about 80 KC, or about 70 KC to about 120 KC.

Tension set is determined according to the following method. Dumbbell samples are marked with a 20 mm bench marking and secured to a tension set apparatus. The samples are then extended 50% (i.e., extending the 20 mm bench marking to 30 mm). The stretched samples are placed in a circulating air oven (105° C.) for 5 hours and then cooled for 2 hours at ambient temperature. After cooling, the samples are unclamped from the tension set apparatus and allowed to relax on a flat non-conductive surface dusted with talcum powder. The final bench mark length is measured to the nearest 0.01 mm after 16 hours of relaxation. Unless otherwise specified, the sample curing conditions are 180° C. and TC 90+5 MDR.

The elastomer blends of the present disclosure may have a tension set (original at 105° C., hot air aged 3 days at 125° C.) of about 9.0% to about 10.5%.

The elastomer blends of the present disclosure may have a tension set (original at 125° C.) of about 24.4% to about 26.5%.

The elastomer blends of the present disclosure may have a tension set (original or green at 125° C., hot air aged 3 days at 125° C.) of about 15.5% to about 17.0%.

Adhesion to self or carcass adhesion peak load refers to the static adhesion between rubber materials and is measured based upon the force to pull apart two layers of compounded material after vulcanization, as measured at room temperature. Samples are die cut in 2.5 cm×15 cm rectangles after vulcanization. Adhesion to self is determined using an Instron instrument at a crosshead speed of 50 mm/min, with data processing using MTS Testworks 4.0 software.

The elastomer blends of the present disclosure may have a self-adhesion peak load of about 150 N to about 300 N.

The elastomer blends of the present disclosure may have a carcass adhesion peak load of about 80 N to about 200 N.

Dampening (tan delta) is determined according to an internal DMA technique. The DMA technique may be used to determine variety of mechanical properties, i.e., complex modulus, E*, storage and loss moduli (E′ and E″) and damping (tan delta) of viscoelastic materials, detect molecular motions, and develop structure-property relationships. DMA applies a sinusoidal deformation, stress or strain, to a sample and measures the viscoelastic response. Measurements are made using a TA Electroforce DMA 3200 instrument operating at a fixed frequency of 15 Hz, an amplitude of ±0.5 mm, and over a temperature range of 25° C. to 120° C.

The elastomer blends of the present disclosure may have a dampening (tan delta, 15 Hz, amplitude ±0.5 mm) at 25° C. of about 0.2 to about 0.3, or about 0.23 to about 0.29, or about 0.26.

The elastomer blends of the present disclosure may have a dampening (tan delta, 15 Hz, amplitude ±0.5 mm) at 50° C. of about 0.1 to about 0.3, or about 0.10 to about 0.25, or about 0.15 to about 0.22, or about 0.19.

The elastomer blends of the present disclosure may have a dampening (tan delta, 15 Hz, amplitude ±0.5 mm) at 100° C. of about 0.1 to about 0.3, or about 0.10 to about 0.25, or about 0.12 to about 0.18, or about 0.16.

The elastomer blends of the present disclosure may have a dampening (tan delta, 15 Hz, amplitude ±0.5 mm) at 120° C. of about 0.1 to about 0.3, or about 0.10 to about 0.25, or about 0.11 to about 0.17, or about 0.15.

Compression set is determined according to ASTM D395-18.

The elastomer blends of the present disclosure may have a compression set of about 35% to about 50%, or about 40% to about 45%.

Barrier and permeability properties of the elastomer blends are determined using an OX-TRAN 2/61 analyzer (Mocon) with WINPERM™ operation software. To conduct the test, a sample is molded to a 0.3 mm thick film and cured at 160° C. before being tested for air permeability using the OX-TRAN instrument. Data is reported as a permeation coefficient in mm·cm³/m²·day or a permeability coefficient in mm·cm³/m²·day·mmHg.

When the companion elastomer is polyisoprene, preferably natural rubber, and the polyisoprene is present in the amounts specified above, the elastomer blends, when vulcanized, may exhibit at least one property exceeding a value for the at least one property for the polyisoprene alone, such as tan delta, hardness, elongation at break, tear resistance, and any combination thereof.

When the companion elastomer is butyl rubber, and the butyl rubber is present in the amounts specified above, the elastomer blends, when vulcanized, may exhibit at least one property exceeding a value for the at least one property for the brominated isobutylene-p-methylstyrene alone, such as tensile strength at break, elongation at break, tear resistance, and any combination thereof, alternately fatigue to failure, energy to break, peak load, tear resistance, or any combination thereof, or alternately adhesion.

The elastomer blends of the present disclosure may be used in a variety of applications or parts. In more specific examples, the elastomer blends may be utilized in air barriers (e.g., tire bladders, tire inner liners, tire inner tubes, and other tire components) and bushings that reduce vibration. According to more specific embodiments, the elastomer blends of the present disclosure may be utilized in vulcanized form in at least one location within a tire and/or during at least one operation of tire manufacturing.

The elastomer blends disclosed herein may be prepared by using conventional mixing techniques including, for example, kneading, roller milling, extruder mixing, internal mixing (such as with a BANBURY™ or BRABENDER™ mixer), and the like. The sequence of mixing and temperatures employed are well known to the skilled rubber compounder, the objective being the dispersion of fillers, activators and curatives in the polymer matrix without excessive heat buildup. A useful mixing procedure may utilize a BANBURY™ mixer in which the elastomers, carbon black and other additives, and plasticizer are added, and the resulting mixture is blended for a desired time or to a particular temperature to achieve adequate dispersion of non-polymeric components. Alternatively, the elastomers and a portion of the carbon black (e.g., one-third to two-thirds) and other components may be mixed for a short time (e.g., about 1 to 5 minutes or about 1 to 3 minutes) followed by the remainder of the carbon black and other components and processing oil. Blending may be continued for about 1 to 10 minutes at high rotor speed during which time the mixture may reach a temperature of about 140° C. Following cooling, the components may be mixed in a second step on a rubber mill or in a BANBURY™ mixer, during which the curing agent and optional accelerators are thoroughly and uniformly dispersed at relatively low temperature, for example, about 80° C. to about 105° C., to avoid premature curing of the composition. Other variations in mixing will be readily apparent to one having ordinary skill in the art and the foregoing blending description should be considered illustrative of that suitable to produce the elastomer blends disclosed herein.

The blending is performed to disperse all components of the elastomer blends thoroughly and uniformly. The resultant elastomer blend may then be formed into various parts, such as one or more components of a tire, for example. In producing such parts, the elastomer blends may become vulcanized.

### Inner Tubes

Preferably, for inner tube applications, the elastomer blends may comprise about 25 wt % to about 90 wt % of a brominated isobutylene-p-methylstyrene copolymer, based on total polymer mass, and a non-zero amount of a companion elastomer that comprises a butyl rubber. More preferably, for inner tube applications, the elastomer blends may comprise about 30 wt % to about 70 wt % of a brominated isobutylene-p-methylstyrene copolymer, based on total polymer mass, and a non-zero amount of a companion elastomer that comprises a butyl rubber.

Preferably, for inner tube applications, the brominated isobutylene-p-methylstyrene copolymer may have a Mooney viscosity of about 30 MU to about 40 MU (e.g., about 35 MU). Further, the brominated isobutylene-p-methylstyrene copolymer may comprise about 3 wt % to about 7 wt %, or about 4 wt % to about 6 wt %, or about 5 wt % p-methylstyrene or brominated p-methylstyrene monomer units and about 0.5 mol % to about 0.9 mol %, or about 0.6 mol % to about 0.8 mol %, or about 0.7 mol % bromine, each based on total mass of the brominated isobutylene-p-methylstyrene copolymer.

For inner tube applications, the companion elastomer may be present at about 25 wt % or above, based on total polymer mass in the elastomer blends, preferably at about 30 wt % or above, based on total polymer mass. More preferably, the companion elastomer may be present at about 30 wt % to about 70 wt % or at about 30 wt % to about 50 wt %, based on total polymer mass within the elastomer blends.

Such elastomer blends suitable for inner tube applications, when vulcanized, may exhibit at least one property exceeding a value for the at least one property for the butyl rubber alone. In non-limiting examples, tensile strength at break, elongation at break, and tear resistance may have a value exceeding the corresponding value for the butyl rubber alone.

Suitable elastomer blends for inner tube applications may have a Mooney viscosity (ML(1+4) at 100° C.) of about 53.0 MU to about 55.0 MU.

Suitable elastomer blends for inner tube applications may have a Mooney scorch (T5, 125° C.) of about 29.0 min or less, or about 10.0 min to about 29.0 min, or about 10.0 min to about 20.0 min, or about 15.0 min to about 29.0 min.

Suitable elastomer blends for inner tube applications may have a MH-ML (moving die rheometer (MDR), 180° C., 30 min, 0.5° test angle) of about 6.0 dNm or less, or about 3.0 dNm to about 6.0 dNm, or about 3.0 dNm to about 5.0 dNm, or about 3.0 dNm to about 4.4 dNm.

Suitable elastomer blends for inner tube applications may have a cure rate index of about 25 or greater (or about 25 to about 60).

Suitable elastomer blends for inner tube applications may have a hardness (original) of about 40 Shore A to about 45 Shore A.

Suitable elastomer blends for inner tube applications may have a hardness (hot air aged 3 days at 125° C.) of about 40 Shore A to about 46 Shore A, or about 40 Shore A to about 45 Shore A).

Suitable elastomer blends for inner tube applications may have a hardness (hot air aged 7 days at 125° C.) of about 40 Shore A to about 44 Shore A.

Suitable elastomer blends for inner tube applications may have a hardness retention (change in hardness) from original to aged (hot air aged 3 days at 125° C.) of about −5 Shore A to about 5 Shore A.

Suitable elastomer blends for inner tube applications may have a hardness retention (change in hardness) from original to aged (hot air aged 7 days at 125° C.) of about −5 Shore A to about 5 Shore A.

Suitable elastomer blends for inner tube applications may have a tensile strength at break (original) of about 10.0 MPa to about 12.0 MPa.

Suitable elastomer blends for inner tube applications may have a tensile strength at break (hot air aged 3 days at 125° C.) of about 8.0 MPa to about 9.0 MPa.

Suitable elastomer blends for inner tube applications may have a tensile strength at break (hot air aged 7 days at 125° C.) of about 6.5 MPa to about 8.5 MPa.

Suitable elastomer blends for inner tube applications may have a tensile strength at break retention (change in tensile strength) from original to aged (hot air aged 3 days at 125° C.) of about 13% to about 30%. The corresponding retention values range from about 70% to about 87%.

Suitable elastomer blends for inner tube applications may have a tensile strength at break retention (change in tensile strength) from original to aged (hot air aged 7 days at 125° C.) of about 15% to about 45%. The corresponding retention values range from about 55% to about 85%.

Suitable elastomer blends for inner tube applications may have an energy at break (original) of about 11.5 J to about 12.5 J.

Suitable elastomer blends for inner tube applications may have an energy at break (hot air aged 3 days at 125° C.) of about 8.0 J to about 9.0 J.

Suitable elastomer blends for inner tube applications may have an energy at break (hot air aged 7 days at 125° C.) of about 7.0 J to about 8.5 J.

Suitable elastomer blends for inner tube applications may have a tear resistance (original) of

about 34 N/mm to about 38 N/mm.

Suitable elastomer blends for inner tube applications may have a tear resistance (hot air aged 3 days at 125° C.) of about 28 N/mm to about 34 N/mm.

Suitable elastomer blends for inner tube applications may have a tear resistance (hot air aged 7 days at 125° C.) of about 23 N/mm to about 30 N/mm.

Suitable elastomer blends for inner tube applications may have a tear resistance retention (change in tear resistance) from original to aged (hot air aged 3 days at 125° C.) of about 12% to about 22%. The corresponding retention values range from about 78% to about 88%.

Suitable elastomer blends for inner tube applications may have a tear resistance retention (change in tear resistance) from original to aged (hot air aged 7 days at 125° C.) of about 22% to about 30%. The corresponding retention values range from about 70% to about 88%.

Suitable elastomer blends for inner tube applications may have a Fatigue to Failure Lifetime Test (FTFT) of about 50 KCs to about 120 KCs, or about 50 KCs to about 80 KCs, or about 70 KCs to about 120 KCs.

Suitable elastomer blends for inner tube applications may have a tension set (original at 105° C.) of about 15% to about 18%.

Suitable elastomer blends for inner tube applications may have a tension set (original at 105° C., hot air aged 3 days at 125° C.) of about 9.0% to about 10.5%.

Suitable elastomer blends for inner tube applications may have a tension set (original at 125° C.,) of about 24.4% to about 26.5%.

Suitable elastomer blends for inner tube applications may have a tension set (original or green at 125° C., hot air aged 3 days at 125° C.) of about 15.5% to about 17.0%.

### Inner Liners

Preferably, for inner liner applications, the elastomer blends may comprise about 25 wt % to about 90 wt % of a brominated isobutylene-p-methylstyrene copolymer, based on total polymer mass, and a non-zero amount of a companion elastomer that comprises a butyl rubber. More preferably, for inner liner applications, the elastomer blends may comprise about 50 wt % to about 90 wt % of a brominated isobutylene-p-methylstyrene copolymer, based on total polymer mass, and a non-zero amount of a companion elastomer that comprises a butyl rubber. Still more preferably, for inner liner applications, the elastomer blends may comprise about 70 wt % to about 90 wt % (e.g., 80 wt %) of a brominated isobutylene-p-methylstyrene copolymer, based on total polymer mass, and a non-zero amount of a companion elastomer that comprises a butyl rubber.

Preferably, for inner liner applications, the brominated isobutylene-p-methylstyrene copolymer may have a Mooney viscosity of about 30 MU to about 40 MU (e.g., about 35 MU). Further, the brominated isobutylene-p-methylstyrene copolymer may comprise about 8 wt % to about 12 wt %, or about 9 wt % to about 11 wt %, or about 10 wt % p-methylstyrene or brominated p-methylstyrene monomer units and about 0.6 mol % to about 1.0 mol %, or about 0.7 mol % to about 0.9 mol %, or about 0.8 mol % bromine, each based on total mass of the brominated isobutylene-p-methylstyrene copolymer.

Such elastomer blends suitable for inner liner applications, when vulcanized, may exhibit enhanced adhesion relative to bromobutyl rubber commonly used for forming inner liners of tires. In general, butyl rubber exhibits decreased adhesion in comparison to bromobutyl rubber. Hence, the ability of brominated isobutylene-p-methylstyrene copolymers to improve adhesion of butyl rubber to a level superior to bromobutyl rubber is particularly surprising.

Suitable elastomer blends for inner liner applications may have a Mooney viscosity (ML(1+4) at 100° C.) of about 53.0 MU to about 65.0 MU.

Suitable elastomer blends for inner liner applications may have a MH-ML (moving die rheometer (MDR), 180° C., 30 min, 0.5° test angle) of about 4.0 dNm or less, or about 3.9 dNm.

Suitable elastomer blends for inner liner applications may have a hardness (original, cured at 175° C.) of about 47 Shore A to about 52 Shore A.

Suitable elastomer blends for inner liner applications may have a self-adhesion peak load of about 150 N to about 300 N.

Suitable elastomer blends for inner liner applications may have a carcass adhesion peak load of about 80 N to about 200 N.

### Bladders

Preferably, for bladder applications, the elastomer blends may comprise about 10 wt % to about 90 wt % of a brominated isobutylene-p-methylstyrene copolymer, based on total polymer mass, and a non-zero amount of a companion elastomer that comprises a butyl rubber. More preferably, for bladder applications, the elastomer blends may comprise about 10 wt % to about 30 wt % or about 10 wt % to about 20 wt % of a brominated isobutylene-p-methylstyrene copolymer, based on total polymer mass, and a non-zero amount of a companion elastomer that comprises butyl rubber.

Preferably, for bladder applications, the brominated isobutylene-p-methylstyrene copolymer may have a Mooney viscosity of about 40 MU to about 50 MU (e.g., about 45 MU). Further, the brominated isobutylene-p-methylstyrene copolymer may comprise about 3 wt % to about 7 wt %, or about 4 wt % to about 6 wt %, or about 5 wt % p-methylstyrene or brominated p-methylstyrene monomer units and about 0.3 mol % to about 0.7 mol %, or about 0.4 mol % to about 0.6 mol %, or about 0.5 mol % bromine, each based on total mass of the brominated isobutylene-p-methylstyrene copolymer.

Such elastomer blends suitable for bladder applications, when vulcanized, may exhibit at least one property exceeding a value for the at least one property for the butyl rubber alone. In non-limiting examples, fatigue to failure, energy to break, peak load, and tear resistance may have a value exceeding the corresponding value for the butyl rubber alone.

Suitable elastomer blends for bladder applications may have a Mooney viscosity (ML(1+4) at 100° C.) of about 68.0 MU to about 73.0 MU.

Suitable elastomer blends for bladder applications may have a Mooney scorch (T5, 125° C.) of about 8.0 min to about 11.0 min.

Suitable elastomer blends for bladder applications may have a MH-ML (moving die rheometer (MDR), 180° C., 30 min, 0.5° test angle) of about 6.0 dNm or less, or about 4.5 dNm to about 6.0 dNm, or about 5.0 dNm to about 6.0 dNm.

Suitable elastomer blends for bladder applications may have a hardness (original) of about 45 Shore A to about 55 Shore A.

Suitable elastomer blends for bladder applications may have a tear resistance (original) of about 37 N/mm to about 42 N/mm.

### Bushings

Preferably, for bushing applications, the elastomer blends may comprise about 30 wt % to about 50 wt % (e.g., 40 wt %) of a brominated isobutylene-p-methylstyrene copolymer, based on total polymer mass, and a non-zero amount of a companion elastomer that comprises a polyisoprene, more preferably natural rubber.

Preferably, for bushing applications, the brominated isobutylene-p-methylstyrene copolymer may have a Mooney viscosity of about 30 MU to about 40 MU (e.g., about 35 MU). Further, the brominated isobutylene-p-methylstyrene copolymer may comprise about 3 wt % to about 7 wt %, or about 4 wt % to about 6 wt %, or about 5 wt % p-methylstyrene or brominated p-methylstyrene monomer units and about 0.5 mol % to about 0.9 mol %, or about 0.6 mol % to about 0.8 mol %, or about 0.7 mol % bromine, each based on total mass of the brominated isobutylene-p-methylstyrene copolymer.

Such elastomer blends suitable for bushing applications, when vulcanized, may exhibit at least one property exceeding a value for the at least one property for the polyisoprene alone. In non-limiting examples, tan delta, hardness, elongation at break, and tear resistance may have a value exceeding a value for the at least one property for the polyisoprene alone.

Suitable elastomer blends for bushing applications may have a Mooney viscosity (ML(1+4) at 100° C.) of about 52 MU to about 56 MU, or about 54 MU.

Suitable elastomer blends for bushing applications may have a Mooney scorch (T5, 125° C.) of about 10.0 min or less, or about 6.5 min to about 10.0 min, or about 7.5 min to about 8.0 min.

Suitable elastomer blends for bushing applications may have a MH-ML (moving die rheometer (MDR), 160° C., 60 min, 0.5° test angle) of about 5.5 dNm to about 7.0 dNm, or about 6.0 dNm to about 7.0 dNm, or about 6.3 dNm.

Suitable elastomer blends for bushing applications may have a hardness (original) of about 48 Shore A to about 55 Shore A (or about 50 Shore A to about 53 Shore A).

Suitable elastomer blends for bushing applications may have a hardness (hot air aged 3 days at 100° C.) of about 54 Shore A to about 57 Shore A, or about 55 Shore A.

Suitable elastomer blends for bushing applications may have a hardness retention (change in hardness) from original to aged (hot air aged 3 days at 100° C.) of about 0 Shore A to about 5 Shore A.

Suitable elastomer blends for bushing applications may have a tensile strength at break (original) of about 18 MPa to about 23 MPa.

Suitable elastomer blends for bushing applications may have a tensile strength at break (hot air aged 3 days at 100° C.) of about 15 MPa to about 20 MPa.

Suitable elastomer blends for bushing applications may have a tensile strength at break retention (change in tensile strength) from original to aged (hot air aged 3 days at 100° C.) of about 13% to about 16%. The corresponding retention values range from about 84% to about 87%.

Suitable elastomer blends for bushing applications may have an energy at break (original) of about 17.0 J to about 23.0 J, or about 20.0 J to about 22.0 J.

Suitable elastomer blends for bushing applications may have an energy at break (hot air aged 3 days at 100° C.) of about 16.0 J to about 21.0 J, or about 17.0 J to about 20.0 J.

Suitable elastomer blends for bushing applications may have a tear resistance (original) of about 55 N/mm to about 70 N/mm, or about 60 N/mm to about 70 N/mm.

Suitable elastomer blends for bushing applications may have a tear resistance (hot air aged 3 days at 100° C.) of about 45 N/mm to about 65 N/mm, or about 50 N/mm to about 60 N/mm.

Suitable elastomer blends for bushing applications may have a tear resistance retention (change in tear resistance) from original to aged (hot air aged 3 days at 100° C.) of about 15% to about 18%. The corresponding retention values range from about 82% to about 85%.

Suitable elastomer blends for bushing applications may have a compression set of about 35% to about 50% (or about 40% to about 45%).

Suitable elastomer blends for bushing applications may have a Fatigue to Failure Lifetime Test (FTFT) of about 35 KCs to about 45 KCs.

Suitable elastomer blends for bushing applications may have a dampening (tan delta, 15 Hz, amplitude ±0.5 mm) at 25° C. of about 0.2 to about 0.3, or about 0.23 to about 0.29, or about 0.26.

Suitable elastomer blends for bushing applications may have a dampening (tan delta, 15 Hz, amplitude ±0.5 mm) at 50° C. of about 0.1 to about 0.3, or about 0.10 to about 0.25, or about 0.15 to about 0.22, or about 0.19.

Suitable elastomer blends for bushing applications may have a dampening (tan delta, 15 Hz, amplitude ±0.5 mm) at 100° C. of about 0.1 to about 0.3, or about 0.10 to about 0.25, or about 0.12 to about 0.18, or about 0.16.

Suitable elastomer blends for bushing applications may have a dampening (tan delta, 15 Hz, amplitude ±0.5 mm) at 120° C. of about 0.1 to about 0.3, or about 0.10 to about 0.25, or about 0.11 to about 0.17, or about 0.15.

### Additional Embodiments

Embodiments disclosed herein include:
A. Elastomer blends. The elastomer blends comprise: about 25 wt % or above of a brominated isobutylene-p-methylstyrene copolymer, based on total polymer mass; and a non-zero amount of a companion elastomer; wherein the companion elastomer is not a bromobutyl rubber; and wherein the brominated isobutylene-p-methylstyrene copolymer is free of a diene comonomer.
A1. Tire or tire components comprising the elastomer blends of A in vulcanized form in at least one location. Ala. Tires comprising an inner liner comprising the elastomer blends of A in vulcanized form. Alb. Tires comprising an inner tube comprising the elastomer blends of A in vulcanized form.
A2. Bladders for forming a tire, the bladders comprising the elastomer blends of A in vulcanized form.
A3. Bushings comprising the elastomer blends of A in vulcanized form.

Embodiments A-A3 may have one or more of the following elements present in any combination.
Element 1: wherein the companion elastomer comprises at least one elastomeric polymer selected from the group consisting of a butyl rubber, a polyisoprene, and any combination thereof.
Element 2: wherein the elastomer blend comprises about 25 wt % to about 90 wt % brominated isobutylene-p-methylstyrene copolymer, based on total polymer mass.
Element 3: wherein the brominated isobutylene-p-methylstyrene copolymer has a Mooney viscosity (ML 1+8, 125° C., ASTM D1646-19a) ranging from about 30 Mooney units to about 50 Mooney units.
Element 4: wherein the brominated isobutylene-p-methylstyrene copolymer comprises about 3 wt % to about 12 wt % p-methylstyrene or brominated p-methylstyrene monomer units and about 0.3 mol % to about 1.0 mol % bromine, each based on total mass of the brominated isobutylene-p-methylstyrene copolymer.
Element 5: wherein the companion elastomer comprises a polyisoprene and the elastomer blend comprises about 30 wt % to about 50 wt % brominated isobutylene-p-methylstyrene copolymer, based on total polymer mass.
Element 6: wherein the brominated isobutylene-p-methylstyrene copolymer has a Mooney viscosity of about 35 Mooney units, and the brominated isobutylene-p-methylstyrene copolymer comprises about 5 wt % p-methylstyrene or brominated p-methylstyrene monomer units and about 0.7 mol % bromine, each based on total mass of the brominated isobutylene-p-methylstyrene copolymer.
Element 7: wherein the elastomer blend when vulcanized, exhibits at least one property exceeding a value for the at least one property for the polyisoprene alone, the at least one property being selected from the group consisting of tan delta, hardness, elongation at break, tear resistance, and any combination thereof.
Element 8: wherein the companion elastomer comprises a butyl rubber and the composition comprises about 25 wt % to about 90 wt % brominated isobutylene-p-methylstyrene copolymer, based on total polymer mass.
Element 9: wherein the elastomer blend comprises about 30 wt % to about 70 wt % brominated isobutylene-p-methylstyrene copolymer, based on total polymer mass.
Element 10: wherein the brominated isobutylene-p-methylstyrene copolymer has a Mooney viscosity of about 35 Mooney units, and the brominated isobutylene-p-methylstyrene copolymer comprises about 5 wt % p-methylstyrene or brominated p-methylstyrene monomer units and about 0.7 mol % bromine, each based on total mass of the brominated isobutylene-p-methylstyrene copolymer.
Element 11: wherein the elastomer blend, when vulcanized, exhibits at least one property exceeding a value for the at least one property for the butyl rubber alone and a value for the at least one property for the brominated isobutylene-p-methylstyrene copolymer alone, the at least one property being selected from the group consisting of tensile strength at break, elongation at break, tear resistance, and any combination thereof.
Element 12: wherein the brominated isobutylene-p-methylstyrene copolymer has a Mooney viscosity of about 45 Mooney units, and the brominated isobutylene-p-methylstyrene copolymer comprises about 5 wt % p-methylstyrene or brominated p-methylstyrene monomer units and about 0.5 mol % bromine, each based on total mass of the brominated isobutylene-p-methylstyrene copolymer.
Element 13: wherein the elastomer blend, when vulcanized, exhibits at least one property exceeding a value for the at least one property for the butyl rubber alone and a value for the at least one property for the brominated isobutylene-p-methylstyrene copolymer alone, the at least one property being selected from the group consisting of fatigue to failure, energy to break, peak load, tear resistance, and any combination thereof.
Element 14: wherein the elastomer blend comprises about 50 wt % to about 90 wt % brominated isobutylene-p-methylstyrene copolymer, based on total polymer mass.
Element 15: wherein the brominated isobutylene-p-methylstyrene copolymer has a Mooney viscosity of about 35 Mooney units, and the brominated isobutylene-p-methylstyrene copolymer comprises about 10 wt % p-methylstyrene or brominated p-methylstyrene monomer units and about 0.8 mol % bromine, each based on total mass of the brominated isobutylene-p-methylstyrene copolymer.
Element 16: wherein the elastomer blend, when vulcanized, exhibits an adhesion value exceeding that of the brominated isobutylene-p-methylstyrene copolymer alone.
Element 17: wherein the elastomer blend is vulcanized.

The present disclosure is further directed to the following non-limiting embodiments:
Embodiment 1. An elastomer blend comprising:
   about 25 wt % or above of a brominated isobutylene-p-methylstyrene copolymer, based on total polymer mass; and
   a non-zero amount of a companion elastomer;
      wherein the companion elastomer is not a bromobutyl rubber; and
      wherein the brominated isobutylene-p-methylstyrene copolymer is free of a diene comonomer.
Embodiment 2. The elastomer blend of Embodiment 1, wherein the companion elastomer comprises at least one elastomeric polymer selected from the group consisting of a butyl rubber, a polyisoprene, and any combination thereof.
Embodiment 3. The elastomer blend of Embodiment 1 or Embodiment 2, wherein the elastomer blend comprises about 25 wt % to about 90 wt % brominated isobutylene-p-methylstyrene copolymer, based on total polymer mass.
Embodiment 4. The elastomer blend of any one of Embodiments 1-3, wherein the brominated isobutylene-p-methylstyrene copolymer has a Mooney viscosity (ML 1+8, 125° C., ASTM D1646-19a) ranging from about 30 Mooney units to about 50 Mooney units.
Embodiment 5. The elastomer blend of any one of Embodiments 1-4, wherein the brominated isobutylene-p-methylstyrene copolymer comprises about 3 wt % to about 12 wt % p-methylstyrene or brominated p-methylstyrene monomer units and about 0.3 mol % to about 1.0 mol % bromine, each based on total mass of the brominated isobutylene-p-methylstyrene copolymer.
Embodiment 6. The elastomer blend of any one of Embodiments 1-5, wherein the companion elastomer comprises a polyisoprene and the elastomer blend comprises about 30 wt % to about 50 wt % brominated isobutylene-p-methylstyrene copolymer, based on total polymer mass.
Embodiment 7. The elastomer blend of Embodiment 6, wherein the brominated isobutylene-p-methylstyrene copolymer has a Mooney viscosity of about 35 Mooney units, and the brominated isobutylene-p-methylstyrene copolymer comprises about 5 wt % p-methylstyrene or brominated p-methylstyrene monomer units and about 0.7 mol % bromine, each based on total mass of the brominated isobutylene-p-methylstyrene copolymer.
Embodiment 8. The elastomer blend of Embodiment 6 or Embodiment 7, wherein the elastomer blend when vulcanized, exhibits at least one property exceeding a value for the at least one property for the polyisoprene alone, the at least one property being selected from the group consisting of tan delta, hardness, elongation at break, tear resistance, and any combination thereof.
Embodiment 9. The elastomer blend of any one of Embodiments 1-5, wherein the companion elastomer comprises a butyl rubber and the composition comprises about 25 wt % to about 90 wt % brominated isobutylene-p-methylstyrene copolymer, based on total polymer mass.
Embodiment 10. The elastomer blend of Embodiment 9, wherein the elastomer blend comprises about 30 wt % to about 70 wt % brominated isobutylene-p-methylstyrene copolymer, based on total polymer mass.
Embodiment 11. The elastomer blend of Embodiment 9 or Embodiment 10, wherein the brominated isobutylene-p-methylstyrene copolymer has a Mooney viscosity of about 35 Mooney units, and the brominated isobutylene-p-methylstyrene copolymer comprises about 5 wt % p-methylstyrene or brominated p-methylstyrene monomer units and about 0.7 mol % bromine, each based on total mass of the brominated isobutylene-p-methylstyrene copolymer.
Embodiment 12. The elastomer blend of Embodiment 10 or Embodiment 11, wherein the elastomer blend, when vulcanized, exhibits at least one property exceeding a value for the at least one property for the butyl rubber alone and a value for the at least one property for the brominated isobutylene-p-methylstyrene copolymer alone, the at least one property being selected from the group consisting of tensile strength at break, elongation at break, tear resistance, and any combination thereof.
Embodiment 13. The elastomer blend of Embodiment 9 or Embodiment 10, wherein the brominated isobutylene-p-methylstyrene copolymer has a Mooney viscosity of about 45 Mooney units, and the brominated isobutylene-p-methylstyrene copolymer comprises about 5 wt % p-methylstyrene or brominated p-methylstyrene monomer units and about 0.5 mol % bromine, each based on total mass of the brominated isobutylene-p-methylstyrene copolymer.
Embodiment 14. The elastomer blend of Embodiment 10 or Embodiment 13, wherein the elastomer blend, when vulcanized, exhibits at least one property exceeding a value for the at least one property for the butyl rubber alone and a value for the at least one property for the brominated isobutylene-p-methylstyrene copolymer alone, the at least one property being selected from the group consisting of fatigue to failure, energy to break, peak load, tear resistance, and any combination thereof.
Embodiment 15. The elastomer blend of Embodiment 9, wherein the elastomer blend comprises about 50 wt % to about 90 wt % brominated isobutylene-p-methylstyrene copolymer, based on total polymer mass.
Embodiment 16. The elastomer blend of Embodiment 9 or Embodiment 15, wherein the brominated isobutylene-p-methylstyrene copolymer has a Mooney viscosity of about 35 Mooney units, and the brominated isobutylene-p-methylstyrene copolymer comprises about 10 wt % p-methylstyrene or brominated p-methylstyrene monomer units and about 0.8 mol % bromine, each based on total mass of the brominated isobutylene-p-methylstyrene copolymer.
Embodiment 17. The elastomer blend of Embodiment 15 or Embodiment 16, wherein the elastomer blend, when vulcanized, exhibits an adhesion value exceeding that of the brominated isobutylene-p-methylstyrene copolymer alone.
Embodiment 18. The elastomer blend of any preceding Embodiment, wherein the elastomer blend is vulcanized.
Embodiment 19. A tire comprising the elastomer blend of Embodiment 1 in vulcanized form in at least one location.
Embodiment 20. The tire of Embodiment 19, wherein an inner tube of the tire comprises the elastomer blend in vulcanized form.
Embodiment 21. The tire of Embodiment 20, wherein the companion elastomer comprises a butyl rubber and the elastomer blend comprises about 25 wt % to about 90 wt % brominated isobutylene-p-methylstyrene copolymer, based on total polymer mass.
Embodiment 22. The composition of Embodiment 20 or Embodiment 21, wherein the brominated isobutylene-p-methylstyrene copolymer has a Mooney viscosity of about 35 Mooney units, and the brominated isobutylene-p-methylstyrene copolymer comprises about 5 wt % p-methylstyrene or brominated p-methylstyrene monomer units and about 0.7 mol % bromine, each based on total mass of the brominated isobutylene-p-methylstyrene copolymer.
Embodiment 23. The tire of Embodiment 19, wherein an inner liner of the tire comprises the elastomer blend in vulcanized form.
Embodiment 24. The tire of Embodiment 23, wherein the companion elastomer comprises a butyl rubber and the composition comprises about 50 wt % to about 90 wt % brominated isobutylene-p-methylstyrene copolymer, based on total polymer mass.
Embodiment 25. The tire of Embodiment 23 or Embodiment 24, wherein the brominated isobutylene-p-methylstyrene copolymer has a Mooney viscosity of about 35 Mooney units, and the brominated isobutylene-p-methylstyrene copolymer comprises about 10 wt % p-methylstyrene or brominated p-methylstyrene monomer units and about 0.8 mol % bromine, each based on total mass of the brominated isobutylene-p-methylstyrene copolymer.
Embodiment 26. A bladder for forming a tire, the bladder comprising the elastomer blend of Embodiment 1 in vulcanized form.
Embodiment 27. The tire of Embodiment 26, wherein the companion elastomer comprises a butyl rubber and the elastomer blend comprises about 25 wt % to about 90 wt % brominated isobutylene-p-methylstyrene copolymer, based on total polymer mass.
Embodiment 28. The tire of Embodiment 26 or Embodiment 27, wherein the brominated isobutylene-p-methylstyrene copolymer has a Mooney viscosity of about 45 Mooney units, and the brominated isobutylene-p-methylstyrene copolymer comprises about 5 wt % p-methylstyrene or brominated p-methylstyrene monomer units and about 0.5 mol % bromine, each based on total mass of the brominated isobutylene-p-methylstyrene copolymer.
Embodiment 29. A bushing comprising the elastomer blend of Embodiment 6 in vulcanized form.
Embodiment 30. The bushing of Embodiment 29, wherein the brominated isobutylene-p-methylstyrene copolymer has a Mooney viscosity of about 35 Mooney units, and the brominated isobutylene-p-methylstyrene copolymer comprises about 5 wt % p-methylstyrene or brominated p-methylstyrene monomer units and about 0.7 mol % bromine, each based on total mass of the brominated isobutylene-p-methylstyrene copolymer.

To facilitate a better understanding of the embodiments of the present disclosure, the following examples of preferred or representative embodiments are given. In no way should the following examples be read to limit, or to define, the scope of the invention.

### EXAMPLES

Example 1. Six elastomer blends were prepared with the compositions of Table 1 under the Banbury mixer mixing conditions of Table 2. The properties of the elastomer blends are provided in Table 3.

TABLE 1

| | Control | Control | Control | Sample | Sample | Sample |
|---|---|---|---|---|---|---|
| | 1 | 2 | 3 | 1-1 | 1-2 | 1-3 |
| Components | (phr) | (phr) | (phr) | (phr) | (phr) | (phr) |
| Butyl rubber | 100.00 | — | — | 70.00 | 50.00 | — |
| EXXON ™ | | | | | | |
| BUTYL 268S | | | | | | |
| Brominated | — | 100.00 | — | 30.00 | 50.00 | 50.00 |
| isobutylene-p- | | | | | | |
| methylstyrene | | | | | | |
| copolymer | | | | | | |
| EXXPRO ™ 3433 | | | | | | |
| Chlorobutyl rubber | — | — | 100.00 | — | — | 50.00 |
| EXXON ™ | | | | | | |
| CHLOROBUTYL | | | | | | |
| 1066 | | | | | | |
| Carbon black | 70.00 | 70.00 | 70.00 | 70.00 | 70.00 | 70.00 |
| N660 | | | | | | |
| Paraffinic oil | 20.00 | 20.00 | 20.00 | 20.00 | 20.00 | 20.00 |
| (IPOL 2300) | | | | | | |
| Stearic acid | 1.00 | 1.00 | 1.00 | 1.00 | 1.00 | 1.00 |
| ESCOREZ ™ 1102 | 3.00 | 3.00 | 3.00 | 3.00 | 3.00 | 3.00 |
| Zinc oxide | 5.00 | — | — | — | — | — |
| Magnesium oxide | — | — | 0.20 | 0.10 | 0.10 | 0.10 |
| | Final batch | | | | | |
| TMTD | 1.00 | 0.40 | 1.00 | 0.75 | 0.75 | 0.70 |
| Zinc oxide | — | 3.00 | 5.00 | 4.40 | 4.00 | 4.00 |
| MBTS | 0.60 | 1.00 | 2.00 | 0.90 | 0.90 | 1.50 |
| Sulfur | 2.00 | 0.15 | — | 1.50 | 1.20 | — |
| Total phr lab | 202.60 | 198.55 | 202.20 | 201.65 | 200.95 | 200.30 |

TABLE 2

| | Control | Control | Control | Sample | Sample |
|---|---|---|---|---|---|
| Condition | 1 | 2 | 3 | 1-1 | 1-2 |
| Start | 50 | 50 | 48 | 55 | 54 |
| Temp. (° C.) | | | | | |
| Dump | 145.6 | 150.0 | 133.9 | 145.5 | 153.1 |
| Temp. (° C.) | | | | | |
| Mixing | 300 | 300 | 270 | 300 | 300 |
| Time (sec) | | | | | |
| Rotor | 77 | 77 | 77 | 77 | 77 |
| Speed (rpm) | | | | | |
| | Final batch | | | | |
| Start | 40 | 36 | 35 | 37 | 37 |
| Temp. (° C.) | | | | | |
| Dump | 100.4 | 90.0 | 91.0 | 98.6 | 99.7 |
| Temp. (° C.) | | | | | |
| Mixing | 90 | 90 | 90 | 90 | 90 |
| Time (sec) | | | | | |
| Rotor | 50 | 50 | 50 | 50 | 50 |
| Speed (rpm) | | | | | |

| Time | |
|---|---|
| (min:sec) | Master batch mixing sequence |
| 0:00 | Add polymers and STRUKTOL ™ 40MS |
| 0:30 | Add ½ of the carbon black |
| 2:00 | Add processing oil, chemicals, and remaining ½ of carbon |
| | black |
| 3:00 | Sweep |
| 5:00 | Dump |
| (4:30 for | |
| Control 2) | |

| Time | |
|---|---|
| (min:sec) | Final batch mixing sequence |
| 0:00 | Add ½ of the master batch and curatives and other half of the |
| | master batch |
| 1:00 | Ram sweep |
| 1:30 | Dump |

TABLE 3

| | Control | Control | Control | Sample | Sample | Sample |
|---|---|---|---|---|---|---|
| Parameter | 1 | 2 | 3 | 1-1 | 1-2 | 1-3 |
| | Mooney viscosity | | | | | |
| Test temp (° C.) | 100 | 100 | 100 | 100 | 100 | 100 |
| Test time (min) | 4 | 4 | 4 | 4 | 4 | 4 |
| Preheat (min) | 1 | 1 | 1 | 1 | 1 | 1 |
| Initial Peak (MU) | 71.0 | 72.0 | 64.9 | 71.0 | 70.9 | 69.0 |
| ML(1 + 4) (MU) | 52.5 | 52.9 | 50.7 | 53.9 | 53.9 | 50.6 |
| | Mooney scorch | | | | | |
| Test temp (° C.) | 125 | 125 | 125 | 125 | 125 | 125 |
| Test time (min) | 60 | 60 | 60 | 60 | 60 | 60 |
| Preheat (min) | 1 | 1 | 1 | 1 | 1 | 1 |
| T1 (min) | 20.43 | 7.37 | 16.88 | 18.90 | 11.75 | 7.97 |
| T2 (min) | 23.77 | 8.71 | 19.23 | 23.33 | 14.19 | 9.53 |
| T3 (min) | 26.08 | 9.72 | 20.60 | 25.70 | 15.77 | 10.62 |
| T5 (min) | 29.38 | 11.20 | 23.27 | 28.23 | 18.05 | 12.42 |
| T10 (min) | 33.43 | 13.32 | 27.28 | 31.11 | 20.87 | 15.07 |
| T18 (min) | 36.25 | 14.88 | 28.65 | 32.97 | 23.28 | 16.50 |
| T20 (min) | 36.73 | 15.13 | 28.82 | 33.27 | 23.72 | 16.69 |
| T35 (min) | 39.36 | 16.37 | 29.68 | 34.94 | 26.16 | 17.60 |
| | Cure properties MDR | | | | | |
| Test temp (° C.) | 180 | 180 | 180 | 180 | 180 | 180 |
| Test time (min) | 30 | 30 | 30 | 30 | 30 | 30 |
| Test angle (°) | 0.5 | 0.5 | 0.5 | 0.5 | 0.5 | 0.5 |
| ML (dNm) | 1.31 | 1.19 | 1.11 | 1.38 | 1.40 | 1.23 |
| MH (dNm) | 10.02 | 6.14 | 5.65 | 5.71 | 5.17 | 5.78 |
| MH − ML (dNm) | 8.70 | 4.95 | 4.54 | 4.34 | 3.77 | 4.55 |
| TS2 (min) | 1.51 | 1.08 | 1.17 | 1.81 | 1.53 | 1.03 |
| TS5 (min) | 2.50 | — | — | — | — | — |
| TC50 (min) | 2.15 | 1.18 | 1.25 | 1.88 | 1.49 | 1.10 |
| TC90 (min) | 6.10 | 2.10 | 2.37 | 4.66 | 2.75 | 2.14 |
| Revert 1% (min) | 14.75 | 10.45 | 11.78 | 14.83 | 14.54 | 11.91 |
| Revert 5% (min) | 19.54 | — | 25.08 | 19.02 | 20.58 | 28.96 |
| Revert 10% (min) | 23.55 | — | — | 23.96 | 27.93 | — |
| | Hardness | | | | | |
| Hardness - | 55 | 49 | 46 | 45 | 42 | 47 |
| Original | | | | | | |
| (Shore A) | | | | | | |
| Hardness aged- | 48 | 56 | 50 | 42 | 44 | 55 |
| Hot air aging for | | | | | | |
| 3 days at 125° C. | | | | | | |
| (Shore A) | | | | | | |
| Hardness aged- | 44 | 58 | 51 | 42 | 44 | 55 |
| Hot air aging for | | | | | | |
| 7 days at 125° C. | | | | | | |
| (Shore A) | | | | | | |
| | Tensile Properties - Original | | | | | |
| Modulus at 100% | 1.67 | 1.81 | 1.23 | 1.19 | 1.09 | 0.77 |
| (MPa) | | | | | | |
| Modulus at 200% | 3.27 | 4.04 | 2.74 | 2.98 | 2.54 | 1.28 |
| (MPa) | | | | | | |
| Modulus at 300% | 4.63 | 6.04 | 4.44 | 5.28 | 4.47 | 3.03 |
| (MPa) | | | | | | |
| Tensile strength | 11.28 | 9.46 | 9.34 | 11.58 | 10.35 | 9.83 |
| at break (MPa) | | | | | | |
| Elongation at | 650 | 650 | 720 | 680 | 720 | 640 |
| break (%) | | | | | | |
| Energy at break | 10.58 | 11.87 | 11.52 | 12.32 | 11.81 | 10.82 |
| (J) | | | | | | |
| | Tensile Properties - Hot air aging for 3 days at 125° C. | | | | | |
| Modulus at 100% | 1.38 | 2.39 | 1.66 | 1.14 | 1.23 | 1.08 |
| (MPa) | | | | | | |
| Modulus at 200% | 2.92 | 5.11 | 3.82 | 2.83 | 2.93 | 2.11 |
| (MPa) | | | | | | |
| Modulus at 300% | 4.30 | 7.44 | 5.90 | 4.73 | 4.93 | 5.19 |
| (MPa) | | | | | | |
| Tensile strength | 7.28 | 9.96 | 9.30 | 8.49 | 8.72 | 10.19 |
| at break (MPa) | | | | | | |
| Elongation at | 600 | 490 | 550 | 600 | 620 | 420 |
| break (%) | | | | | | |
| Energy at break | 7.34 | 8.81 | 8.80 | 8.16 | 8.96 | 7.00 |
| (J) | | | | | | |
| | Tensile Properties - Hot air aging for 7 days at 125° C. | | | | | |
| Modulus at 100% | 0.89 | 2.70 | 1.73 | 1.08 | 1.22 | 2.27 |
| (MPa) | | | | | | |
| Modulus at 200% | 1.64 | 5.84 | 4.04 | 2.45 | 2.77 | 5.45 |
| (MPa) | | | | | | |
| Modulus at 300% | 2.41 | 8.36 | 6.20 | 4.06 | 4.60 | 8.27 |
| (MPa) | | | | | | |
| Tensile strength | 3.82 | 10.08 | 8.82 | 7.02 | 8.12 | 10.52 |
| at break (MPa) | | | | | | |
| Elongation at | 600 | 420 | 490 | 600 | 590 | 420 |
| break (%) | | | | | | |
| Energy at break | 4.12 | 7.23 | 6.95 | 7.25 | 7.98 | 7.50 |
| (J) | | | | | | |
| | Tear Resistance | | | | | |
| Tear resistance | 31.69 | 34.62 | 37.08 | 34.50 | 37.73 | 35.16 |
| (Die C) - Original | | | | | | |
| (N/mm) | | | | | | |
| Tear resistance | 28.83 | 34.54 | 30.88 | 27.93 | 32.33 | 32.97 |
| (Die C)- Hot air | | | | | | |
| aging for 3 days | | | | | | |
| at 125° C. (N/mm) | | | | | | |
| Tear resistance | 17.12 | 31.60 | 29.26 | 24.50 | 29.02 | 31.16 |
| (Die C)- Hot air | | | | | | |
| aging for 7 days | | | | | | |
| at 125° C. (N/mm) | | | | | | |
| | Fatigue to Failure Lifetime Test (FTFT) | | | | | |
| FTFT - Original | 17.4 | 81.6 | 116.7 | 73.1 | 114.9 | 125.7 |
| (kilocycles) | | | | | | |
| | Tension Set - 5 hours, 50% extension Original | | | | | |
| Tension set avg | 18.4 | 13.2 | 15.1 | 17.1 | 15.3 | 16.7 |
| (Original - | | | | | | |
| 105° C.) (%) | | | | | | |
| Tension set avg | 27.1 | 22.5 | 21.4 | 26.3 | 25.0 | 29.5 |
| (Original - | | | | | | |
| 125° C.) (%) | | | | | | |
| | Tension Set 5 hours, 50% extension | | | | | |
| | Hot air aging for 3 days at 125° C. | | | | | |
| Tension set avg | 13.9 | 8.1 | 8.4 | 10.1 | 9.6 | 8.2 |
| (Aged - 105° C.) | | | | | | |
| (%) | | | | | | |
| Tension set avg | 26.2 | 13.4 | 14.0 | 16.1 | 16.7 | 12.9 |
| (Aged - 125° C.) | | | | | | |
| (%) | | | | | | |
| | Retention of Tensile and Tear Properties | | | | | |
| | After hot air aging for 3 days at 125° C. | | | | | |
| Hardness | −7 | 7 | 4 | −3 | 2 | 4 |
| (Shore A) | | | | | | |
| Tensile strength | 35.46 | −5.29 | 0.43 | 26.68 | 15.75 | 0.43 |
| (%) | | | | | | |
| Elongation at | 8.33 | 32.65 | 30.91 | 13.33 | 16.13 | 30.91 |
| break (%) | | | | | | |
| Tear strength (%) | 9.02 | 0.23 | 16.72 | 19.04 | 14.31 | 16.72 |
| | Retention of Tensile and Tear Properties | | | | | |
| | After hot air aging for 7 days at 125° C. | | | | | |
| Hardness | −11 | 9 | 5 | −3 | 2 | 5 |
| (Shore A) | | | | | | |
| Tensile strength | 66.13 | −6.55 | 5.57 | 39.38 | 21.55 | 5.57 |
| (%) | | | | | | |
| Elongation at | 8.33 | 54.76 | 46.94 | 13.33 | 22.03 | 46.94 |
| break (%) | | | | | | |
| Tear strength (%) | 45.98 | 8.72 | 21.09 | 28.99 | 23.09 | 21.09 |

In Table 3, for tensile, tear and hardness measurements, curing was conducted at 180° C., TC 90+2 MDR.

Increasing reversion resistance may translate to maintenance of properties over time, which may improve a tire component's life cycle. Comparing the curing properties Revert 1%, Revert 5%, and Revert 10%, blending the EXXPRO™ 3433 with EXXON™ BUTYL 268S (Samples 1-1 and 1-2) increased the reversion resistance. Reversion values not reported in Table 3 are indicative that under the testing conditions, the elastomer blend did not reach the indicated level of reversion (e.g., 1%, 5%, or 10%). Thus, the blends of EXXPRO™ 3433 with EXXON™ BUTYL 268S experienced comparable or improved reversion relative to the butyl rubber itself.

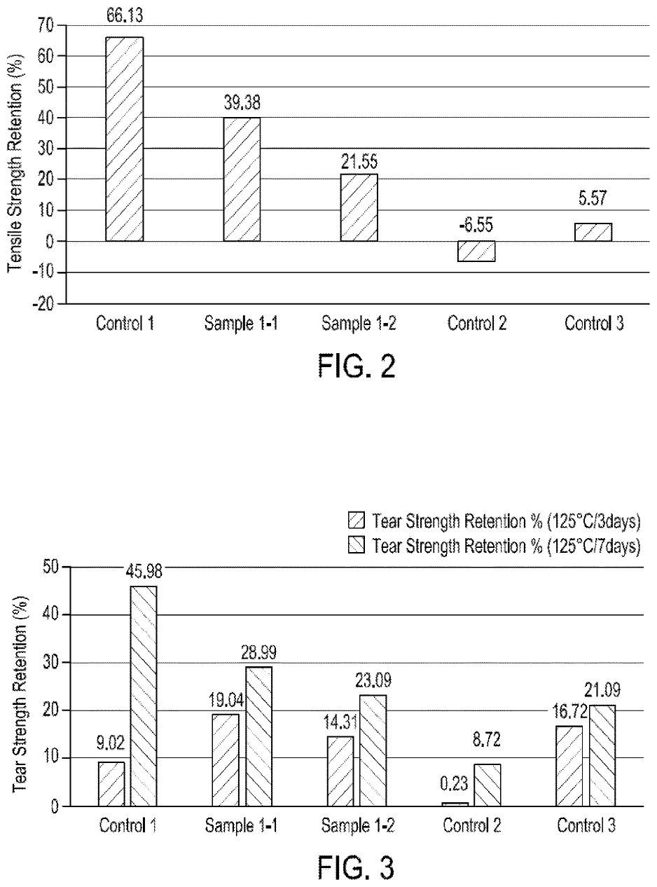

FIGS. 2 and 3 are plots of tensile strength retention and tear strength retention, respectively, after aging the samples of Example 1 under hot air aging at 125° C. for 3 days or 7 days. Tensile strength reduction is shown in FIG. 2 after 7 days of hot air aging at 125° C., and tear strength retention is shown in FIG. 3 after 3 day or 7 days of hot air aging at 125° C. As shown, EXXON™ BUTYL 268S (Control 1) degraded during hot air aging by virtue of its high tensile strength retention of 66.13% and high tear strength retention of 45.93%. The lower values of Samples 1-1 and 1-2 are indicative of better retention of tensile and tear properties afforded by blending EXXPRO™ 3433 with the EXXON™ BUTYL 268S. Increased tensile strength retention and tear strength retention may correlate to an increased life cycle for the elastomer blends.

Higher FTFT values are also indicative of an increased life cycle. As shown in Table 3, blending EXXPRO™ 3433 into the EXXON™ BUTYL 268S increased the FTFT performance.

Lower values for tension set before or after aging are also indicative of an increased life cycle. As shown in Table 3, blending EXXPRO™ 3433 into the EXXON™ BUTYL 268S likewise decreased the tension set values.

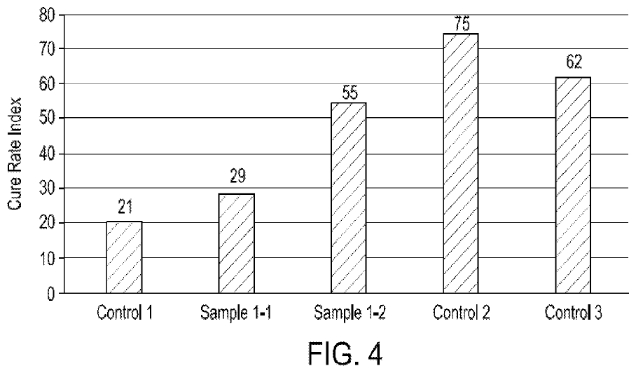

FIG. 4 is a plot of cure rate index (CRI) for the elastomer blends of Example 1. Higher CRI translates to a reduced curing time and energy savings. As shown, Samples 1-1 and 1-2 exhibited a higher cure rate index than did the EXXON™ BUTYL 268S butyl rubber control.

Therefore, as shown in Table 3, at least one of Samples 1-1 and 1-2 exhibited original tensile strength at break, original elongation at break, energy at break, original tear resistance, and FTFT performance.
Example 2. Five elastomer blends were prepared with the compositions specified in Table 4. The properties of the elastomer blends are provided in Table 5.

TABLE 4

| | Bromobutyl | | | | |
|---|---|---|---|---|---|
| | Rubber | | | | |
| | Comparative | | Sample | Sample | Sample |
| Components | Sample | Control | 2-1 | 2-2 | 2-3 |
| Bromobutyl | 100.00 | — | — | — | — |
| rubber | | | | | |
| EXXON ™ | | | | | |
| BROMOBUTYL | | | | | |
| 2222 | | | | | |
| Brominated | — | 100.00 | 80.00 | 80.00 | 80.00 |
| isobutylene-p- | | | | | |
| methylstyrene | | | | | |
| copolymer | | | | | |
| EXXPRO ™ | | | | | |
| 3563 | | | | | |
| Butyl Rubber | — | — | 20.00 | — | — |
| EXXON ™ | | | | | |
| BUTYL 365 | | | | | |
| Butyl Rubber | — | — | — | 20.00 | — |
| EXXON ™ | | | | | |
| BUTYL 065 | | | | | |
| Butyl Rubber | — | — | — | — | 20.00 |
| EXXON ™ | | | | | |
| BUTYL 268 | | | | | |
| Carbon black | 60.00 | 60.00 | 60.00 | 60.00 | 60.00 |
| N660 | | | | | |
| CALSOL 810 | 8.00 | 8.00 | 8.00 | 8.00 | 8.00 |
| STRUKTOL | 7.00 | 7.00 | 7.00 | 7.00 | 7.00 |
| 40MS | | | | | |
| ESCOREZ ™ | 4.00 | 4.00 | 4.00 | 4.00 | 4.00 |
| 1102 | | | | | |
| Stearic acid | 1.00 | 1.00 | 1.00 | 1.00 | 1.00 |
| Magnesium | 0.15 | 0.15 | 0.15 | 0.15 | 0.15 |
| oxide | | | | | |
| | Final batch | | | | |
| Zinc oxide | 1.00 | 1.00 | 1.00 | 1.00 | 1.00 |
| MBTS | 1.25 | 1.25 | 1.25 | 1.25 | 1.25 |
| Sulfur | 0.50 | 0.50 | 0.50 | 0.50 | 0.50 |
| Total phr lab | 182.90 | 182.90 | 182.90 | 182.90 | 182.90 |

TABLE 5

| | Bromobutyl | | | | |
|---|---|---|---|---|---|
| | Rubber | | | | |
| | Comparative | | Sample | Sample | Sample |
| Property | Sample | Control | 2-1 | 2-2 | 2-3 |
| Mooney viscosity | 56.9 | 60.2 | 60.4 | 61.2 | 64.2 |
| ML(1 + 4) (MU) | | | | | |
| MH − ML (dNm) | 4.0 | 5.1 | 3.9 | 3.9 | 4.1 |
| TC50 (min) | 2.9 | 4.6 | 3.9 | 3.8 | 3.8 |
| TC90 (min) | 5.2 | 9.5 | 8.0 | 7.8 | 7.8 |
| Green strength, | 0.35 | 0.47 | 0.49 | 0.41 | 0.46 |
| Modulus at 100% | | | | | |
| (MPa) | | | | | |
| Hardness A; Unaged | 41.0 | 49.0 | 49.0 | 49.0 | 49.0 |
| after Curing at 175° C. | | | | | |
| (Shore A) | | | | | |
| Stress at Break; aged 3 | 9.4 | 11.1 | 10.0 | 9.9 | 10.2 |
| days at 125° C. (MPa) | | | | | |
| Strain at Break; aged 3 | 556 | 507 | 697 | 716 | 676 |
| days at 125° C. (%) | | | | | |
| Modulus at 100%, | 1.0 | 1.8 | 1.5 | 1.4 | 1.5 |
| cured at 175° C. for | | | | | |
| 15 min (MPa) | | | | | |
| Modulus at 300%, | 3.4 | 4.9 | 3.5 | 3.4 | 3.7 |
| cured at 175° C. for | | | | | |
| 15 (MPa) | | | | | |
| Stress at Break (MPa) | 10.5 | 9.0 | 7.4 | 7.5 | 8.1 |
| Strain at Break (%) | 766 | 709 | 833 | 889 | 867 |
| TEST vs Self | Self | Self | Self | Self | Self |
| Test Temp. (° C.) | 23 | 23 | 23 | 23 | 23 |
| Speed (mm/min) | 50.8 | 50.8 | 50.8 | 50.8 | 50.8 |
| Self-Adhesion, Peak | 226.61 | 182.15 | 291.13 | 156.95 | — |
| Load (N) | | | | | |
| Tear Resist (N/mm) | 8.313 | 5.082 | 7.574 | 4.422 | 3.137 |
| Tear Type | Interfaced | Interfaced | Interfaced | Interfaced | Interfaced |
| Adhesion (carcass), | 128 | 130 | 89 | 187 | 166 |
| Peak Load (N) | | | | | |
| Tear Resist (N/mm) | 3.136 | 3.431 | 1.501 | 5.028 | 4.305 |
| Tear Type | Interfaced | Interfaced | Interfaced | Interfaced | Interfaced |
| Permeability | 0.275 | 0.231 | 0.261 | 0.228 | 0.227 |
| mm · cm³/m² · day · mmHg | | | | | |

As shown in Table 5, depending on measurement type, Samples 2-1 and 2-2 exhibited increased adhesion relative to the comparative bromobutyl rubber. Likewise, depending on measurement type, the measured adhesion was higher than that of the brominated isobutylene-p-methylstyrene copolymer in some cases.

As shown, gas permeability for the samples was superior to that of bromobutyl rubber, and in some cases, the permeability was even slightly lower than that of the brominated isobutylene-p-methylstyrene copolymer itself.
Example 3. Nine elastomer blends were prepared with the compositions specified in Table 6. Properties of the rubber blends are provided in Table 7.

TABLE 6

| | Control 1 | Control 2 | | | |
|---|---|---|---|---|---|
| | (butyl | (Exxpro | Sample | Sample | Sample |
| Components | rubber) | only) | 3-1 | 3-2 | 3-3 |
| Butyl rubber | 100.00 | — | 89.88 | 79.78 | 69.71 |
| EXXON ™ | | | | | |
| BUTYL 268S | | | | | |
| Brominated | — | 100.00 | 10.12 | 20.22 | 30.29 |
| isobutylene-p- | | | | | |
| methylstyrene | | | | | |
| copolymer | | | | | |
| EXXPRO ™ 3035 | | | | | |
| Carbon black | — | 50.00 | 5.06 | 10.11 | 15.14 |
| N234 | | | | | |
| Carbon black | 50.00 | — | 44.94 | 39.89 | 34.86 |
| N330 | | | | | |
| ESCOREZ ™ | — | 18.00 | 1.82 | 3.64 | 5.45 |
| 5600 | | | | | |
| Castor oil | 5.00 | — | 4.49 | 3.99 | 3.49 |
| Neoprene type W | 5.00 | — | 4.49 | 3.99 | 3.49 |
| Stearic acid | 1.00 | 0.50 | 0.95 | 0.90 | 0.85 |
| | Final batch | | | | |
| Phenolic resin | 10.00 | 3.00 | 9.29 | 8.58 | 7.88 |
| MBTS | — | 1.60 | 0.16 | 0.32 | 0.48 |
| Zinc oxide | 5.00 | 0.40 | 4.53 | 4.07 | 3.61 |
| Magnesium oxide | — | 0.10 | 0.01 | 0.02 | 0.03 |
| Total phr lab | 176.00 | 173.60 | 175.76 | 175.51 | 175.27 |

| Components | Sample 3-4 | Sample 3-5 | Sample 3-6 | Sample 3-7 |
|---|---|---|---|---|
| Butyl rubber | 49.66 | 29.71 | 19.78 | 9.88 |
| EXXON ™ | | | | |
| BUTYL 268S | | | | |
| Brominated | 50.34 | 70.29 | 80.22 | 90.12 |
| isobutylene-p- | | | | |
| methylstyrene | | | | |
| copolymer | | | | |
| EXXPRO ™ | | | | |
| 3035 | | | | |
| Carbon black | 25.17 | 35.14 | 40.11 | 45.06 |
| N234 | | | | |
| Carbon black | 24.83 | 14.86 | 9.89 | 4.94 |
| N330 | | | | |
| ESCOREZ ™ | 9.06 | 12.65 | 14.44 | 16.22 |
| 5600 | | | | |
| Castor oil | 2.48 | 1.49 | 0.99 | 0.49 |
| Neoprene type | 2.48 | 1.49 | 0.99 | 0.49 |
| W | | | | |
| Stearic acid | 0.75 | 0.65 | 0.60 | 0.55 |
| | Final batch | | | |
| Phenolic resin | 6.48 | 5.08 | 4.38 | 3.69 |
| MBTS | 0.81 | 1.12 | 1.28 | 1.44 |
| Zinc oxide | 2.68 | 1.77 | 1.31 | 0.85 |
| Magnesium | 0.05 | 0.07 | 0.08 | 0.09 |
| oxide | | | | |
| Total phr lab | 174.79 | 174.31 | 174.07 | 173.84 |

TABLE 7

| | Control | Control | Sample | Sample | Sample |
|---|---|---|---|---|---|
| Property | 1 | 2 | 3-1 | 3-2 | 3-3 |
| Mooney viscosity | 75.7 | 72.9 | 69.7 | 70.7 | 70.7 |
| ML(1 + 4) (MU) | | | | | |
| Mooney Scorch - | 12.6 | 14.8 | 10.6 | 8.9 | 8.5 |
| T5 (min) | | | | | |
| MH − ML (dNm) | 6.64 | 5.94 | 5.23 | 5.02 | 4.93 |
| TC25 (min) | 1.9 | 2.32 | 1.69 | 1.43 | 1.28 |
| TC90 (min) | 6.8 | 16.96 | 14.83 | 13.32 | 11.59 |
| Hardness (Shore A) | 52.5 | 55.9 | 49.1 | 48.5 | 49.2 |
| FTFT (Cycles | ND | 54005 | 81875 | 224423 | 263564 |
| performed) | | | | | |
| FTFT (Cycles | ND | 19640 | 54458 | 103052 | 26067 |
| standard deviation) | | | | | |
| Modulus at 300% | 6.89 | 4.83 | 3.86 | 4.22 | 4.59 |
| (MPa) | | | | | |
| Energy To Break | 14.13 | 14.07 | 15.48 | 14.44 | 16.54 |
| (J) | | | | | |
| Break Stress (MPa) | 15.687 | 14.171 | 14.62 | 14.194 | 14.793 |
| Break Strain (%) | 608.03 | 715.39 | 789.29 | 760.23 | 776.17 |
| Peak Load (N) | 73.14 | 69.15 | 71.3 | 71.33 | 74.85 |
| Tear Resistance | 39.11 | 38.12 | 37.55 | 37.6 | 38.99 |
| (N/mm) | | | | | |

TABLE 7
continued

| | Sample | Sample | Sample | Sample |
|---|---|---|---|---|
| Property | 3-4 | 3-5 | 3-6 | 3-7 |
| Mooney viscosity | 70.8 | 71.2 | 71.1 | 71.6 |
| ML(1 + 4) (MU) | | | | |
| Mooney Scorch - T5 | 8.4 | 8.8 | 9.5 | 10.5 |
| (min) | | | | |
| MH − ML (dNm) | 5.13 | 5.43 | 5.65 | 5.92 |
| TC25 (min) | 1.11 | 1.07 | 1.11 | 1.23 |
| TC90 (min) | 9.71 | 7.03 | 6.78 | 6.59 |
| Hardness (Shore A) | 53 | 54 | 51.4 | 53.6 |
| FTFT (Cycles | 125274 | 82086 | 58931 | 56045 |
| performed) | | | | |
| FTFT (Cycles standard | 49182 | 38180 | 19611 | 15958 |
| deviation) | | | | |
| Modulus at 300% | 5.43 | 5.77 | 5.87 | 6.68 |
| (MPa) | | | | |
| Energy To Break (J) | 15.49 | 16.41 | 16.38 | 13.2 |
| Break Stress (MPa) | 14.467 | 15.02 | 15.335 | 15.228 |
| Break Strain (%) | 719.95 | 713.31 | 699.57 | 603.89 |
| Peak Load (N) | 79.3 | 75.55 | 75.12 | 77.24 |
| Tear Resistance | 40.88 | 40.19 | 40.39 | 39.24 |
| (N/mm) | | | | |

As shown in Table 7, over the range of 10 phr to 30 phr brominated isobutylene p-methylstyrene copolymer, the elastomer blends exhibited considerably improved fatigue to failure performance relative to the controls. The improved fatigue to failure performance may be advantageous for constructing and reusing bladders multiple times during a tire manufacturing process. In addition, energy to break, break stress, and break strain were higher than either of the controls in some cases.
Example 4. Two elastomer blends were prepared as specified in Table 8 under the Banbury mixer mixing conditions of Table 9. Properties of the rubber blends are provided in Table 10.

TABLE 8

| | | Sample |
|---|---|---|
| Components | Control | 4-1 |
| Natural rubber RSS 4 | 100.00 | 60.00 |
| Brominated isobutylene p- | — | 40.00 |
| methylstyrene copolymer | | |
| EXXPRO ™ 3433 | | |
| Carbon black N330 | — | 45.00 |
| Carbon black N550 | 24.00 | — |
| STRUKTOL ™ 40MS | — | 5.00 |
| Naphthenic oil | 6.00 | 5.00 |
| Magnesium oxide | — | 0.10 |
| Zinc oxide | 5.00 | — |
| Stearic acid | 2.00 | 1.00 |
| TMQ | 1.50 | 0.50 |
| 6PPD | 2.00 | 1.00 |
| Microcrystalline wax | — | 1.00 |

Final batch

| | | |
|---|---|---|
| Zinc Oxide | — | 3.00 |
| VULTAC ™ #5 | — | 1.00 |
| MBTS | — | 0.60 |
| Sulfur | 2.10 | 0.80 |
| CBS | 1.20 | — |
| 2-(cyclohexylthio)-1H- | — | 0.10 |
| isoindole-1,3(2H)-dione | | |
| Total phr lab | 143.8 | 164.10 |

^{a}VULTAC ™ #5 (Pennwalt) is an alkyl phenol disulfide stabilizing additive.

TABLE 9

| | | |
|---|---|---|
| Components | Control | Sample 4-1 |

Master batch

| | | |
|---|---|---|
| Start Temp. (° C.) | 45.0 | 45.0 |
| Dump Temp. (° C.) | 124.1 | 135.0 |
| Mixing Time (sec) | 300 | 300 |
| Rotor Speed (rpm) | 75 | 75 |

Final batch

| | | |
|---|---|---|
| Start Temp. (° C.) | 35.0 | 35.0 |
| Dump Temp. (° C.) | 88.0 | 95.0 |
| Mixing Time (sec) | 120 | 120 |
| Rotor Speed (rpm) | 40 | 40 |

| Time | |
|---|---|
| (min:sec) | Master batch mixing sequence |
| 0:00 | Add polymers and STRUKTOL ™ 40MS |
| 0:30 | Add chemicals and carbon black |
| 2:00 | Add processing oil |
| 3:00 | Sweep |
| 5:00 | Dump |

| Time | |
|---|---|
| (min:sec) | Final batch mixing sequence |
| 0:00 | Add ½ of the master batch and curatives and other half of the |
| | master batch |
| 1:00 | Ram sweep |
| 2:00 | Dump |

TABLE 10

| | | Sample |
|---|---|---|
| Property | Control | 4-1 |

Mooney viscosity

| | | |
|---|---|---|
| Test temp. (° C.) | 100 | 100 |
| Test time (min) | 4 | 4 |
| Preheat (min) | 1 | 1 |
| Initial Peak (MU) | 49.0 | 71.9 |
| ML(1 + 4) (MU) | 30.9 | 53.9 |

Mooney scorch

| | | |
|---|---|---|
| Test temp. (° C.) | 125 | 125 |
| Test time (min) | 60 | 60 |
| Preheat (min) | 1 | 1 |
| T1 (min) | 14.50 | 5.43 |
| T2 (min) | 15.38 | 6.20 |
| T3 (min) | 15.86 | 6.83 |
| T5 (min) | 16.41 | 7.87 |
| T10 (min) | 16.94 | 10.06 |
| T20 (min) | 17.48 | 14.11 |
| T35 (min) | 18.13 | 19.75 |

Cure properties MDR

| | | |
|---|---|---|
| Test temp. (° C.) | 160 | 160 |
| Test time (min) | 60 | 60 |
| Test angle (°) | 0.5 | 0.5 |
| ML (dNm) | 0.83 | 1.80 |
| MH (dNm) | 10.00 | 8.12 |
| MH − ML (dNm) | 9.17 | 6.32 |
| TS2 (min) | 1.83 | 1.97 |
| TS5 (min) | 2.22 | 4.40 |
| TC50 (min) | 2.16 | 2.69 |
| TC90 (min) | 3.17 | 6.05 |
| Revert 1% (min) | 5.82 | 18.15 |
| Revert 5% (min) | 7.89 | 26.68 |
| Revert 10% (min) | 10.86 | 41.85 |

Damping (tan delta) -
Frequency 15 Hz and
Amplitude +/− 0.5 mm

| | | |
|---|---|---|
| Tan delta @ 25° C. | 0.043 | 0.261 |
| Tan delta @ 50° C. | 0.032 | 0.186 |
| Tan delta @ 100° C. | 0.028 | 0.157 |
| Tan delta @ 120° C. | 0.025 | 0.149 |

Hardness

| | | |
|---|---|---|
| Hardness - Original | 46 | 52 |
| (Shore A) | | |
| Hardness aged- | 53 | 55 |
| Hot air aging | | |
| for 3 days at | | |
| 100° C. (Shore A) | | |

Tensile - Original

| | | |
|---|---|---|
| Modulus at 100% (MPa) | 1.52 | 1.54 |
| Modulus at 200% (MPa) | 3.58 | 3.35 |
| Modulus at 300% (MPa) | 6.99 | 5.75 |
| Tensile strength at | 26.24 | 20.91 |
| break (MPa) | | |
| Elongation at break (%) | 580 | 730 |
| Energy at break (J) | 16.56 | 21.20 |

Tensile - Hot air aging for
3 days at 100° C.

| | | |
|---|---|---|
| Modulus at 100% (MPa) | 2.23 | 1.93 |
| Modulus at 200% (MPa) | 5.85 | 4.40 |
| Modulus at 300% (MPa) | 10.78 | 7.35 |
| Tensile strength at | 21.69 | 17.92 |
| break (MPa) | | |
| Elongation at break (%) | 470 | 630 |
| Energy at break (J) | 14.00 | 18.32 |

Tear resistance

| | | |
|---|---|---|
| Tear resistance (Die C) - | 47.93 | 65.57 |
| Original (N/mm) | | |
| Tear resistance (Die C) - | 38.09 | 54.77 |
| Hot air aging for 3 days | | |
| at 100° C. (N/mm) | | |

Compression set

| | | |
|---|---|---|
| Comp. set - 25%/22 hrs/ | 23 | 42 |
| 70° C. (%) | | |

FTFT

| | | |
|---|---|---|
| FTFT - Original | 31.3 | 40.8 |

Retention of Tensile and Tear
Properties after hot air aging
for 3 days at 100° C.

| | | |
|---|---|---|
| Hardness (Shore A) | 7 | 3 |
| Tensile Strength (%) | 17.33 | 14.29 |
| Elongation at break (%) | 18.96 | 13.69 |
| Tear Resistance (%) | 20.52 | 16.47 |

In Table 10, for tensile, tear and hardness measurements, curing was conducted at 160° C., TC 90+2 MDR, and for compression set, curing was conducted at 160° C., TC 90+5 MDR.

As shown, Sample 4-1 could be dumped at a higher temperature in comparison to the Control, which may reduce the mixing cycle and energy consumption.

Comparing the scorch safety cure properties (TS2 and TS5), higher values for Sample 4-1 are indicative of less premature vulcanization.

Bushings are often used for extended periods of time. Higher values for the reversion resistance (Revert 1%, Revert 5%, and Revert 10%) indicate that Sample 4-1 may better maintain its properties over time relative to the control.

As shown in Table 10, natural rubber degrades with hot air aging as characterized by its high tensile strength retention of 17.33% and high tear strength retention of 20.52%. Blending of EXXPRO™ 3433 with natural rubber considerably increased the tensile strength retention and tear strength retention, which may afford an increased life cycle.

Higher FTFT values are also indicative of an increased life cycle. Blending of EXXPRO™ 3433 with natural rubber increased FTFT performance and may lead to a longer life cycle.

Lower change values for hardness and elongation to break after aging are also indicative of a longer life cycle. Blending of EXXPRO™ 3433 with natural rubber reduced the change in hardness from 7 Shore A to 3 Shore A and reduced the change in elongation to break from 18.96% to 13.69%, which may afford an increased life cycle.

The higher tan delta values for Sample 4-1 over a range of temperatures correlates with improvement of dampening performance. The dampening improvement may be advantageous for producing bushing and dampening vibrations therewith.

Many alterations, modifications, and variations will be apparent to one having ordinary skill in the art in light of the foregoing description without departing from the spirit or scope of the present disclosure and that when numerical limits and numerical upper limits are listed herein, ranges from any lower limit to any upper limit are contemplated.

All documents described herein are incorporated by reference herein for purposes of all jurisdictions where such practice is allowed, including any priority documents and/or testing procedures to the extent that they are not inconsistent with this text. As is apparent from the foregoing general description and the specific embodiments, while forms of the disclosure have been illustrated and described, various modifications may be made without departing from the spirit and scope of the disclosure. Accordingly, it is not intended that the disclosure be limited thereby. For example, the compositions described herein may be free of any component, or composition not expressly recited or disclosed herein. Any method may lack any step not recited or disclosed herein. Likewise, the term “comprising” is considered synonymous with the term “including.” Whenever a method, composition, element or group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the embodiments of the present disclosure. At the very least, and not as an attempt to limit the application of the doctrine of equivalents to the scope of the claim, each numerical parameter should at least be construed in light of the number of reported significant digits and by applying ordinary rounding techniques.

Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

One or more illustrative embodiments are presented herein. Not all features of a physical implementation are described or shown in this application for the sake of clarity. It is understood that in the development of a physical embodiment of the present disclosure, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for one of ordinary skill in the art and having benefit of this disclosure.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to one having ordinary skill in the art and having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present disclosure. The embodiments illustratively disclosed herein suitably may be practiced in the absence of any element that is not specifically disclosed herein and/or any optional element disclosed herein.

The invention claimed is:

1. An elastomer blend comprising:
about 25 wt % or above of a brominated isobutylene-p-methylstyrene copolymer, based on total polymer mass; and
a non-zero amount of a companion elastomer;
wherein the companion elastomer is not a bromobutyl rubber; and
wherein the brominated isobutylene-p-methylstyrene copolymer is free of a diene comonomer.

2. The elastomer blend of claim 1, wherein the companion elastomer comprises at least one elastomeric polymer selected from the group consisting of a butyl rubber, a polyisoprene, and any combination thereof.

3. The elastomer blend of claim 2, wherein the elastomer blend comprises about 25 wt % to about 90 wt % brominated isobutylene-p-methylstyrene copolymer, based on total polymer mass.

4. The elastomer blend of claim 2, wherein the brominated isobutylene-p-methylstyrene copolymer has a Mooney viscosity (ML 1+8, 125° C., ASTM D1646-19a) ranging from about 30 Mooney units to about 50 Mooney units.

5. The elastomer blend of claim 2, wherein the brominated isobutylene-p-methylstyrene copolymer comprises about 3 wt % to about 12 wt % p-methylstyrene or brominated p-methylstyrene monomer units and about 0.3 mol % to about 1.0 mol % bromine, each based on total mass of the brominated isobutylene-p-methylstyrene copolymer.

6. The elastomer blend of claim 1, wherein the companion elastomer comprises a polyisoprene and the elastomer blend comprises about 30 wt % to about 50 wt % brominated isobutylene-p-methylstyrene copolymer, based on total polymer mass.

7. The elastomer blend of claim 6, wherein the brominated isobutylene-p-methylstyrene copolymer has a Mooney viscosity of about 35 Mooney units, and the brominated isobutylene-p-methylstyrene copolymer comprises about 5 wt % p-methylstyrene or brominated p-methylstyrene monomer units and about 0.7 mol % bromine, each based on total mass of the brominated isobutylene-p-methylstyrene copolymer.

8. The elastomer blend of claim 7, wherein the elastomer blend when vulcanized, exhibits at least one property exceeding a value for the at least one property for the polyisoprene alone, the at least one property being selected from the group consisting of tan delta, hardness, elongation at break, tear resistance, and any combination thereof.

9. The elastomer blend of claim 1, wherein the companion elastomer comprises a butyl rubber and the composition comprises about 25 wt % to about 90 wt % brominated isobutylene-p-methylstyrene copolymer, based on total polymer mass.

10. The elastomer blend of claim 9, wherein the elastomer blend comprises about 30 wt % to about 70 wt % brominated isobutylene-p-methylstyrene copolymer, based on total polymer mass.

11. The elastomer blend of claim 10, wherein the brominated isobutylene-p-methylstyrene copolymer has a Mooney viscosity of about 35 Mooney units, and the brominated isobutylene-p-methylstyrene copolymer comprises about 5 wt % p-methylstyrene or brominated p-methylstyrene monomer units and about 0.7 mol % bromine, each based on total mass of the brominated isobutylene-p-methylstyrene copolymer.

12. The elastomer blend of claim 11, wherein the elastomer blend, when vulcanized, exhibits at least one property exceeding a value for the at least one property for the butyl rubber alone and a value for the at least one property for the brominated isobutylene-p-methylstyrene copolymer alone, the at least one property being selected from the group consisting of tensile strength at break, elongation at break, tear resistance, and any combination thereof.

13. The elastomer blend of claim 9, wherein the brominated isobutylene-p-methylstyrene copolymer has a Mooney viscosity of about 45 Mooney units, and the brominated isobutylene-p-methylstyrene copolymer comprises about 5 wt % p-methylstyrene or brominated p-methylstyrene monomer units and about 0.5 mol % bromine, each based on total mass of the brominated isobutylene-p-methylstyrene copolymer.

14. The elastomer blend of claim 13, wherein the elastomer blend, when vulcanized, exhibits at least one property exceeding a value for the at least one property for the butyl rubber alone and a value for the at least one property for the brominated isobutylene-p-methylstyrene copolymer alone, the at least one property being selected from the group consisting of fatigue to failure, energy to break, peak load, tear resistance, and any combination thereof.

15. The elastomer blend of claim 9, wherein the elastomer blend comprises about 50 wt % to about 90 wt % brominated isobutylene-p-methylstyrene copolymer, based on total polymer mass.

16. The elastomer blend of claim 15, wherein the brominated isobutylene-p-methylstyrene copolymer has a Mooney viscosity of about 35 Mooney units, and the brominated isobutylene-p-methylstyrene copolymer comprises about 10 wt % p-methylstyrene or brominated p-methylstyrene monomer units and about 0.8 mol % bromine, each based on total mass of the brominated isobutylene-p-methylstyrene copolymer.

17. The elastomer blend of claim 16, wherein the elastomer blend, when vulcanized, exhibits an adhesion value exceeding that of the brominated isobutylene-p-methylstyrene copolymer alone.

18. The elastomer blend of claim 1, wherein the elastomer blend is vulcanized.

19. A tire comprising the elastomer blend of claim 1 in vulcanized form in at least one location.

20. The tire of claim 19, wherein an inner tube of the tire comprises the elastomer blend in vulcanized form.

21. The tire of claim 20, wherein the companion elastomer comprises a butyl rubber and the elastomer blend comprises about 25 wt % to about 90 wt % brominated isobutylene-p-methylstyrene copolymer, based on total polymer mass.

22. The composition of claim 21, wherein the brominated isobutylene-p-methylstyrene copolymer has a Mooney viscosity of about 35 Mooney units, and the brominated isobutylene-p-methylstyrene copolymer comprises about 5 wt % p-methylstyrene or brominated p-methylstyrene monomer units and about 0.7 mol % bromine, each based on total mass of the brominated isobutylene-p-methylstyrene copolymer.

23. The tire of claim 19, wherein an inner liner of the tire comprises the elastomer blend in vulcanized form.

24. The tire of claim 23, wherein the companion elastomer comprises a butyl rubber and the composition comprises about 50 wt % to about 90 wt % brominated isobutylene-p-methylstyrene copolymer, based on total polymer mass.

25. The tire of claim 24, wherein the brominated isobutylene-p-methylstyrene copolymer has a Mooney viscosity of about 35 Mooney units, and the brominated isobutylene-p-methylstyrene copolymer comprises about 10 wt % p-methylstyrene or brominated p-methylstyrene monomer units and about 0.8 mol % bromine, each based on total mass of the brominated isobutylene-p-methylstyrene copolymer.

26. A bladder for forming a tire, the bladder comprising the elastomer blend of claim 1 in vulcanized form.

27. The tire of claim 26, wherein the companion elastomer comprises a butyl rubber and the elastomer blend comprises about 25 wt % to about 90 wt % brominated isobutylene-p-methylstyrene copolymer, based on total polymer mass.

28. The tire of claim 27, wherein the brominated isobutylene-p-methylstyrene copolymer has a Mooney viscosity of about 45 Mooney units, and the brominated isobutylene-p-methylstyrene copolymer comprises about 5 wt % p-methylstyrene or brominated p-methylstyrene monomer units and about 0.5 mol % bromine, each based on total mass of the brominated isobutylene-p-methylstyrene copolymer.

29. A bushing comprising the elastomer blend of claim 6 in vulcanized form.

30. The bushing of claim 29, wherein the brominated isobutylene-p-methylstyrene copolymer has a Mooney viscosity of about 35 Mooney units, and the brominated isobutylene-p-methylstyrene copolymer comprises about 5 wt % p-methylstyrene or brominated p-methylstyrene monomer units and about 0.7 mol % bromine, each based on total mass of the brominated isobutylene-p-methylstyrene copolymer.
